(19) United States
(12) Patent Application Publication
(10) Pub. No.: US 2013/0280529 A1
(43) Pub. Date: Oct. 24, 2013

(54) ADHESIVE COMPOSITION FOR OPTICAL FILMS, ADHESIVE LAYER FOR OPTICAL FILMS, PRESSURE-SENSITIVE ADHESIVE LAYER-CARRYING OPTICAL FILM, AND IMAGE DISPLAY DEVICE

(71) Applicants: Yuusuke Toyama, Ibaraki-shi (JP); Atsushi Yasui, Ibaraki-shi (JP); Tomoyuki Kimura, Ibaraki-shi (JP); Masayuki Satake, Ibaraki-shi (JP); Shusaku Goto, Ibaraki-shi (JP); Takeharu Kitagawa, Ibaraki-shi (JP); Minoru Miyatake, Ibaraki-shi (JP); Tomohiro Mori, Ibaraki-shi (JP); Takashi Kamijo, Ibaraki-shi (JP)

(72) Inventors: Yuusuke Toyama, Ibaraki-shi (JP); Atsushi Yasui, Ibaraki-shi (JP); Tomoyuki Kimura, Ibaraki-shi (JP); Masayuki Satake, Ibaraki-shi (JP); Shusaku Goto, Ibaraki-shi (JP); Takeharu Kitagawa, Ibaraki-shi (JP); Minoru Miyatake, Ibaraki-shi (JP); Tomohiro Mori, Ibaraki-shi (JP); Takashi Kamijo, Ibaraki-shi (JP)

(73) Assignee: NITTO DENKO CORPORATION, Ibaraki-shi, Osaka (JP)

(21) Appl. No.: 13/993,256

(22) PCT Filed: Dec. 12, 2011
(86) PCT No.: PCT/JP2011/078672

§ 371 Date: Jun. 11, 2013

(30) Foreign Application Priority Data
Dec. 13, 2010 (JP) 2010-277229
May 27, 2011 (JP) 2011-119155

(51) Int. Cl. G02B 1/04

(52) U.S. Cl. CPC G02B 1/04
USPC 428/355 AC; 428/339; 524/558

(57) ABSTRACT

A pressure-sensitive adhesive composition for use on an optical film, includes a (meth)acryl-based polymer obtained by copolymerization of 30 to 98.9% by weight of an alkyl(meth)acrylate, 1 to 50% by weight of an aromatic ring-containing polymerizable monomer, and 0.1 to 20% by weight of a hydroxyl group-containing monomer, and a solvent. The (meth)acryl-based polymer is free of any carboxyl group-containing monomer unit and has a weight average molecular weight of 300,000 to 1,200,000 as measured by gel permeation chromatography. The content of a solid including the (meth)acryl-based polymer is 20% by weight or more, and the content of the solvent is 80% by weight or less.

### TECHNICAL FIELD

The present invention relates to a pressure-sensitive adhesive composition for use on an optical film, which can have high removability (reworkability) and high adhesion durability. The present invention also relates to a pressure-sensitive adhesive layer-carrying optical film including an optical film and a pressure-sensitive adhesive layer made from such a pressure-sensitive adhesive composition on at least one side of the optical film. The present invention also relates to an image display device, such as a liquid crystal display device, an organic electroluminescence (EL) display device, a CRT, or a PDP, produced with such a pressure-sensitive adhesive layer-carrying optical film and to a member for use together with an image display device, such as a front face plate, produced with such a pressure-sensitive adhesive layer-carrying optical film. Examples of the optical film include a polarizing plate, a retardation plate, an optical compensation film, a brightness enhancement film, a surface treatment film such as an anti-reflection film, and a laminate of any combination thereof.

### BACKGROUND ART

Liquid crystal display devices, organic EL display devices, etc. have an image-forming mechanism including polarizing elements as essential components. For example, therefore, in a liquid crystal display device, polarizing elements are essentially arranged on both sides of a liquid crystal cell, and generally, polarizing plates are attached as the polarizing elements. Besides polarizing plates, various optical elements for improving display quality have become used in display panels such as liquid crystal panels and organic EL panels. Front face plates are also used to protect image display devices such as liquid crystal display devices, organic EL display devices, CRTs, and PDPs or to provide a high-grade appearance or a differentiated design. Examples of parts used in image display devices such as liquid crystal display devices and organic EL display devices or parts used together with image display devices, such as front face plates, include retardation plates for preventing discoloration, viewing angle-widening films for improving the viewing angle of liquid crystal displays, brightness enhancement films for increasing the contrast of displays, and surface treatment films such as hard-coat films for use in imparting scratch resistance to surfaces, anti-glare treatment films for preventing glare on image display devices, and anti-reflection films such as anti-reflective films and low-reflective films. These films are generically called optical films.

When such optical films are bonded to a display panel such as a liquid crystal cell or an organic EL panel or bonded to a front face plate, a pressure-sensitive adhesive is generally used. In the process of bonding an optical film to a display panel such as a liquid crystal cell or an organic EL panel or to a front face plate or bonding optical films together, a pressure-sensitive adhesive is generally used to bond the materials together so that optical loss can be reduced. In such a case, a pressure-sensitive adhesive layer-carrying optical film including an optical film and a pressure-sensitive adhesive layer previously formed on one side of the optical film is generally used, because it has some advantages such as no need for a drying process to fix the optical film.

In the process of bonding a pressure-sensitive adhesive layer-carrying optical film to a liquid crystal cell, they can be misaligned, or a contaminant can be caught between the bonded surfaces. In such a case, the pressure-sensitive adhesive layer-carrying optical film may be peeled off from the liquid crystal panel and the liquid crystal cell thereon is to be reused. When peeled off from the liquid crystal panel, the pressure-sensitive adhesive layer-carrying optical film is required not to have an adhesive state that can change the gap of the liquid crystal cell or break the optical film. In other words, the pressure-sensitive adhesive layer-carrying optical film is required to have removability (reworkability) so that it can be easily peeled off. However, if the tackiness is simply improved with the emphasis on the durability of the pressure-sensitive adhesive layer-carrying optical film, the removability will be reduced.

Acryl-based pressure-sensitive adhesives are usually used to form pressure-sensitive adhesive layer-carrying optical films, because of their advantages such as high weather resistance and transparency. When an acryl-based pressure-sensitive adhesive is used to form a pressure-sensitive adhesive layer, a high-molecular-weight polymer is usually used to form the pressure-sensitive adhesive.

Proposed examples include a pressure-sensitive adhesive for use on optical members, which contains 15% by weight or less of an acrylic polymer component with a weight average molecular weight of 100,000 or less and 10% by weight or more of an acrylic polymer component with a weight average molecular weight of 1,000,000 or more (Patent Document 1); a pressure-sensitive adhesive for use on optical members, which contains an acrylic polymer with a weight average molecular weight of 500,000 or more and a Mw/Mn ratio of 4 or less and an epoxy group-containing silane coupling agent (Patent Document 2); and a pressure-sensitive adhesive for use on optical members, which contains carboxyl, hydroxyl, and amide groups as essential moieties and has a weight average molecular weight of 1,000,000 to 2,000,000 (Patent Document 3). Also disclosed is a pressure-sensitive adhesive for use on optical members, which contains an acrylic polymer having a gel fraction of 50 to 90% and containing uncrosslinked components with a weigh average molecular weight of 100,000 or more (Patent Document 4).

Unfortunately, a solution of an acrylic polymer with a weight average molecular weight of 1,000,000 or more has a high viscosity, and thus such a solution should have a concentration of up to about 15% by weight so that it can be applied to a variety of backing films. If the concentration is higher than this value, there will be a problem in that rough coating surfaces can be formed during the application or a solvent should be used in a large amount. On the other hand, if the polymer has a relatively low molecular weight, the concentration can be increased to 40% by weight. In this case, however, durability will be insufficient. According to Patent Documents 1 and 4, the solid concentration can be 40% by weight and 20% by weight, respectively, but there is a problem in that a complicated process is necessary to remove low-molecular-weight components from the polymer.

There is a further problem in that a relatively large amount of a contaminant (microgel) can be formed as a byproduct during the synthesis of an acrylic polymer with a relatively high molecular weight. In a manufacturing process, a pressure-sensitive adhesive composition usually undergoes repeated mesh filtration for removal of contaminants, and even in a final sorting process, any contaminant on an optical film should be removed. If a large amount of microgel is formed, however, the number of steps for removing the contaminant will increase, so that the productivity of the process until the application of the composition will significantly decrease. If the amount of microgel is strictly specified for the final sorting process, yield can significantly decrease. There has also been a problem in that even if the amount of microgel is strictly specified, there can be a high risk of commercial distribution of defective items that cannot be finally rejected. Now, as the penetration of LED backlights increase, their brightness becomes higher. In general, the level of microgel in a conventional pressure-sensitive adhesive composition is acceptable when such a composition is applied to an adherend for use at a low backlight brightness or at a low panel contrast. However, if such a composition is applied to an adherend for use with a high-brightness LED backlight, the problem of microgel-induced defects can occur. In addition, the penetration of touch panel displays has also increased in the field of mobile applications. Thus, there has been an increase in applications where a touch panel (particularly, a touch panel having an uppermost surface of indium tin oxide (ITO) or HC/PET) is used, in place of glass (the material to be bonded conventionally), as the adherend. It is also necessary to improve corrosion resistance and removability when the adherend is a touch panel having an uppermost surface of ITO or the like, in contrast to when the adherend has glass or a film laminate at its uppermost surface as in conventional applications. Thus, more strict requirements have been imposed on display quality, and in view of both process yield and quality control, there has been a strong demand for removal of a contaminant (microgel) from pressure-sensitive adhesives and for improvement in corrosion resistance or removability.

Now attention is focused on a polarizing plate having a thin polarizer with a thickness of 10 μm or less for purposes such as reducing the thickness of large display elements, avoiding display unevenness, and reducing industrial waste. Such a polarizing plate having a thin polarizer may have the following problems with display quality:

(i) microgel can be physically deposited on its surface (to form surface irregularities) because the polarizer is thin;
(ii) microgel-induced defects can be easily observed when light is reflected, because the polarizer is thin.
Also, to prevent appearance defects caused by the problem (i) or (ii), it is particularly necessary to remove microgel from a pressure-sensitive adhesive composition for use on a polarizing plate having a thin polarizer with a thickness of 10 μm or less.

Patent Document 5 listed below describes a pressure-sensitive adhesive composition in which a (meth)acryl-based polymer obtained by polymerization of a monomer mixture containing 1 to 8% by weight of a carboxyl group-containing monomer is crosslinked with a large amount of an isocyanate crosslinking agent. Patent Document 6 listed below describes a pressure-sensitive adhesive composition containing a (meth)acryl-based polymer and a crosslinking accelerator. Patent Document 7 describes a pressure-sensitive adhesive sheet obtained by polymerization of monomers including acrylic acid. Unfortunately, the formation of microgel cannot be reduced in the pressure-sensitive adhesive layer described in these documents.

### PRIOR ART DOCUMENTS

### Patent Documents

Patent Document 1: JP-A-64-66283
Patent Document 2: JP-A-07-20314
Patent Document 3: JP-A-09-59580
Patent Document 4: JP-A-10-46125
Patent Document 5: JP-A-2010-196003
Patent Document 6: JP-A-2009-522667
Patent Document 7: JP-A-2009-173746

### SUMMARY OF THE INVENTION

### Problems to be Solved by the Invention

It is an object of the present invention, which has been accomplished in view of the above circumstances, to provide a pressure-sensitive adhesive composition for use on optical films, which has high removability, can achieve high durability, high coating surface smoothness, and low solvent consumption in a well-balanced way, and can form a pressure-sensitive adhesive layer with reduced formation of microgel.

It is another object of the present invention to provide a pressure-sensitive adhesive composition that can be used as a raw material for a pressure-sensitive adhesive layer to be formed on at least one side of a polarizing plate having a thin polarizer with a thickness of 10 μm or less and can form such a pressure-sensitive adhesive layer with reduced formation of microgel.

### Means for Solving the Problems

As a result of earnest study to solve the above problems, the inventors have found that (i) as the molecular weight of a (meth)acryl-based polymer in a pressure-sensitive adhesive composition for use on optical films increases, the polymer becomes more likely to form gel because of its production process, so that the content of microgel in a solution can easily increase and large microgel can easily occur; and that (ii) when the raw material monomers for a (meth)acryl-based polymer include a carboxyl group-containing monomer, such as acrylic acid, polymer gelation can easily occur during the synthesis or storage of the (meth)acryl-based polymer. As a result of further earnest study based on the finding, the inventors have found that all the above problems can be solved when the raw material monomers for a (meth)acryl-based polymer do not include any carboxyl group-containing monomer and the molecular weight of the (meth)acryl-based polymer is within a specific range. The present invention, which has been accomplished as a result of the study, achieves the objects by virtue of the features described below.

Specifically, the present invention is directed to a pressure-sensitive adhesive composition for use on an optical film, including: a (meth)acryl-based polymer; and a solvent, wherein the (meth)acryl-based polymer includes a product obtained by copolymerization of 30 to 98.9% by weight of an alkyl(meth)acrylate, 1 to 50% by weight of an aromatic ring-containing polymerizable monomer, and 0.1 to 20% by weight of a hydroxyl group-containing monomer, the (meth)acryl-based polymer is free of any carboxyl group-containing monomer unit, and the (meth)acryl-based polymer has a weight average molecular weight of 300,000 to 1,200,000 as measured by gel permeation chromatography. The pressure-sensitive adhesive composition of the present invention has a solid content of 20% by weight or more and a solvent content of 80% by weight or less, wherein the solid includes the (meth)acryl-based polymer.

In the pressure-sensitive adhesive composition for use on an optical film, the aromatic ring-containing polymerizable monomer is preferably benzyl(meth)acrylate.

In the pressure-sensitive adhesive composition for use on an optical film, the hydroxyl group-containing monomer is preferably 4-hydroxybutyl acrylate.

The pressure-sensitive adhesive composition for use on an optical film preferably contains 0.02 to 2 parts by weight of a radical generating agent based on 100 parts by weight of the (meth)acryl-based polymer.

The pressure-sensitive adhesive composition for use on an optical film preferably contains 0.01 to 5 parts by weight of an isocyanate crosslinking agent based on 100 parts by weight of the (meth)acryl-based polymer.

The present invention is also directed to a pressure-sensitive adhesive layer for use on an optical film, including a product made from any of the pressure-sensitive adhesive compositions stated above for use on an optical film.

The present invention is also directed to a pressure-sensitive adhesive layer-carrying optical film including an optical film and the pressure-sensitive adhesive layer formed on at least one side of the optical film.

In the pressure-sensitive adhesive layer-carrying optical film, the optical film is preferably a polarizing plate including a polarizer and a transparent protective film or films provided on one or both sides of the polarizer, and the polarizer preferably has a thickness of 10 μm or less.

### Effect of the Invention

The pressure-sensitive adhesive composition of the present invention for use on an optical film can achieve high removability, high durability, high coating surface smoothness, and low solvent consumption in a well-balanced way because it is produced using a (meth)acryl-based polymer that has a specific molecular weight and is obtained by copolymerization of an alkyl(meth)acrylate, an aromatic ring-containing polymerizable monomer, and a hydroxyl group-containing monomer in a specific ratio. The amount of microgel produced in the pressure-sensitive adhesive layer is also successfully reduced because the molecular weight of the (meth)acryl-based polymer falls within the specified range and the raw material monomers for the (meth)acryl-based polymer do not include any carboxyl group-containing monomer, such as acrylic acid. Thus, the pressure-sensitive adhesive composition of the present invention for use on an optical film is particularly useful for bonding materials to high-brightness applications such as those having an LED backlight, specifically, LED backlight-equipped image display devices.

As described above, the amount of microgel production in a pressure-sensitive adhesive layer can be reduced when the pressure-sensitive adhesive composition of the present invention for use on an optical film is used as a raw material to form the pressure-sensitive adhesive layer. Thus, when the pressure-sensitive adhesive composition is used as a raw material to form a pressure-sensitive adhesive layer on at least one side of a polarizing plate having a polarizer with a thickness of 10 μm or less, microgel-induced appearance defects can be prevented in the resulting pressure-sensitive adhesive layer-carrying optical film.

The pressure-sensitive adhesive composition may be bonded to the conductive metal thin film layer of a touch panel layer, which is formed on an image display cell such as a liquid crystal panel or an organic EL (OLED) panel in order to provide a touch panel function. In this case, corrosion prevention will be important, and higher removability will be required because the tackiness to the adherend tends to be higher, in contrast to cases where the pressure-sensitive adhesive composition is bonded to glass or the like. In the pressure-sensitive adhesive composition of the present invention for use on an optical film, the (meth)acryl-based polymer whose weight average molecular weight is adjusted to 1,200,000 or less can have low cohesive strength and improved removability, and the (meth)acryl-based polymer whose weight average molecular weight is adjusted to 300,000 or more can be prevented from bleeding and can have improved affinity for the adherend. In addition, because the raw material monomers for the (meth)acryl-based polymer do not include any carboxyl group-containing monomer, such as acrylic acid, the pressure-sensitive adhesive composition of the present invention does not cause corrosion of metal thin films (including metal oxide thin films) and has improved removability. Thus, the pressure-sensitive adhesive composition of the present invention is suitable for use on parts to which a film having a metal thin film such as an ITO film is to be laminated.

If an image display device, such as a liquid crystal display device, produced with a pressure-sensitive adhesive layer-carrying optical film such as a pressure-sensitive adhesive layer-carrying polarizing plate is exposed to heat or humid conditions, display unevenness such as peripheral unevenness or corner unevenness may be caused by a white spot at a peripheral part of a liquid crystal panel or the like, so that display defects may occur. In contrast, the pressure-sensitive adhesive layer of the pressure-sensitive adhesive layer-carrying optical film of the present invention, which is produced using the pressure-sensitive adhesive composition stated above, can suppress the occurrence of display unevenness at the peripheral part of the display screen. In the pressure-sensitive adhesive composition of the present invention for use on an optical film, the (meth)acryl-based polymer as a base polymer contains a monomer unit derived from an aromatic ring-containing polymerizable monomer in addition to a monomer unit derived from an alkyl(meth)acrylate. Display unevenness at the peripheral part seems to be suppressed because of the use of such an aromatic ring-containing polymerizable monomer.

### MODE FOR CARRYING OUT THE INVENTION

The pressure-sensitive adhesive composition of the present invention for use on an optical film contains a (meth)acryl-based polymer as a base polymer. The (meth)acryl-based polymer includes monomer units derived from an alkyl(meth)acrylate, an aromatic ring-containing polymerizable monomer, and a hydroxyl group-containing monomer. As used herein, the term“(meth)acrylate” means acrylate and/or methacrylate, and “(meth)” is used in the same meaning in the description.

An alkyl(meth)acrylate may be used to form the main skeleton of the (meth)acryl-based polymer. Such an alkyl(meth)acrylate may have a straight- or branched-chain alkyl group of 1 to 18 carbon atoms. For example, such an alkyl group may be methyl, ethyl, propyl, isopropyl, butyl, isobutyl, amyl, hexyl, cyclohexyl, heptyl, 2-ethylhexyl, isooctyl, nonyl, decyl, isodecyl, dodecyl, isomyristyl, lauryl, tridecyl, pentadecyl, hexadecyl, heptadecyl, or octadecyl. These may be used alone or in any combination. The average carbon number of such alkyl groups is preferably from 3 to 9. In the present invention, the use of n-butyl acrylate, which is an alkyl(meth)acrylate having an n-butyl group, is particularly preferred. An alkyl(meth)acrylate preferably constitutes 30 to 98.9% by weight, more preferably 50 to 98.9% by weight, even more preferably 67 to 98.9% by weight of the (meth)acryl-based polymer.

The aromatic ring-containing polymerizable monomer may be a compound having an aromatic group in its structure and having a polymerizable unsaturated double bond moiety such as a (meth)acryloyl group or a vinyl group. The aromatic ring-containing polymerizable monomer constitutes 1 to 50% by weight, preferably 1 to 30% by weight of the (meth)acryl-based polymer. The aromatic group may be a benzene ring, a naphthalene ring, a biphenyl ring, or a heterocyclic ring. The heterocyclic ring may be a morpholine ring, a piperidine ring, a pyrrolidine ring, or a piperazine ring. For example, such a compound may be an aromatic group-containing (meth)acrylate.

Examples of the aromatic group-containing (meth)acrylate include benzyl(meth)acrylate, phenyl(meth)acrylate, o-phenylphenol(meth)acrylate, phenoxy(meth)acrylate, phenoxyethyl(meth)acrylate, phenoxypropyl(meth)acrylate, phenoxydiethylene glycol(meth)acrylate, ethylene oxide-modified nonylphenol(meth)acrylate, ethylene oxide-modified cresol(meth)acrylate, phenol ethylene oxide-modified (meth)acrylate, 2-hydroxy-3-phenoxypropyl(meth)acrylate, methoxybenzyl(meth)acrylate, chlorobenzyl(meth)acrylate, cresyl(meth)acrylate, polystyryl(meth)acrylate, and other benzene ring-containing (meth)acrylates; hydroxyethylated β-naphthol acrylate, 2-naphthethyl(meth)acrylate, 2-naphthoxyethyl acrylate, 2-(4-methoxy-1-naphthoxy)ethyl(meth)acrylate, and other naphthalene ring-containing (meth)acrylates; and biphenyl(meth)acrylate and other biphenyl ring-containing (meth)acrylates.

Examples of the heterocyclic ring-containing (meth)acrylate include thiol(meth)acrylate, pyridyl(meth)acrylate, and pyrrole(meth)acrylate. Other examples of the heterocyclic ring-containing (meth)acryl-based monomer include N-acryloyl morpholine, N-acryloyl piperidine, N-methacryloyl piperidine, and N-acryloyl pyrrolidine.

Examples of the aromatic group-containing vinyl compound include vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amides, styrene, and α-methylstyrene.

In view of pressure-sensitive adhesive properties and durability, the aromatic ring-containing polymerizable monomer is preferably an aromatic group-containing (meth)acrylate. Among them, benzyl(meth)acrylate or phenoxyethyl(meth)acrylate is preferred, and benzyl(meth)acrylate is particularly preferred.

In the present invention, the (meth)acryl-based polymer also includes a hydroxyl group-containing monomer as another component. The hydroxyl group-containing monomer preferably includes a hydroxyl group-containing monomer having an alkyl group of 4 to 6 carbon atoms and at least one hydroxyl group. Specifically, such a monomer is a hydroxyalkyl group-containing monomer having 4 to 6 carbon atoms and one or more hydroxyl groups. Such a compound preferably has the hydroxyl group at the end of the alkyl group. The alkyl group preferably has 4 to 6 carbon atoms. Within this range, a preferred level of gel fraction can be achieved, and a pressure-sensitive adhesive layer with high workability can be formed.

Such a monomer may be of any type having a hydroxyl group and a polymerizable functional group containing a (meth)acryloyl unsaturated double bond. Examples include hydroxyalkyl(meth)acrylates such as 2-hydroxyethyl(meth)acrylate, 2-hydroxybutyl(meth)acrylate, 2-hydroxypropyl(meth)acrylate, 2-hydroxypentyl(meth)acrylate, 2-hydroxyhexyl(meth)acrylate, 3-hydroxypropyl(meth)acrylate, 4-hydroxybutyl(meth)acrylate, and 6-hydroxyhexyl(meth)acrylate; and 4-hydroxymethylcyclohexyl(meth)acrylate and 4-hydroxybutyl vinyl ether. Among them, an acrylate such as 4-hydroxybutyl acrylate, 5-hydroxypentyl acrylate, or 6-hydroxyhexyl acrylate is preferably used, and 4-hydroxybutyl acrylate is particularly preferred.

The hydroxyl group-containing monomer constitutes 0.1 to 20% by weight, preferably 0.5 to 5% by weight, more preferably 0.1 to 3% by weight of the (meth)acryl-based polymer. To form a pressure-sensitive adhesive layer with improved durability, the use of 3 to 5% by weight of the hydroxyl group-containing monomer is particularly preferred. In the present invention, the (meth)acryl-based polymer has a weight average molecular weight of 300,000 to 1,200,000. When such a low-molecular-weight polymer is used as a base polymer in the pressure-sensitive adhesive composition, it is important to control the cross-linkability of the base polymer. Particularly when an isocyanate crosslinking agent is used, too high a content of the hydroxyl group-containing monomer unit in the (meth)acryl-based polymer can easily cause the formation of microgel during a reaction with the isocyanate, or too low a content of the hydroxyl group-containing monomer unit in the (meth)acryl-based polymer can make it difficult to crosslink the polymer, which may have an adverse effect on durability.

The copolymerization ratio among the alkyl(meth)acrylate, the aromatic ring-containing polymerizable monomer, and the hydroxyl group-containing monomer used to form the (meth)acryl-based polymer is 30-98.9% by weight (the alkyl(meth)acrylate): 1-50% by weight (the aromatic ring-containing polymerizable monomer): 0.1-20% by weight (the hydroxyl group-containing monomer). In the present invention, the (meth)acryl-based polymer is also characterized by being free of any carboxyl group-containing monomer unit. The problems described above are solved when the copolymerization ratio among the alkyl(meth)acrylate, the aromatic ring-containing polymerizable monomer, and the hydroxyl group-containing monomer used to form the (meth)acryl-based polymer falls within the specified range, provided that the (meth)acryl-based polymer is free of any carboxyl group-containing monomer unit.

In the present invention, the (meth)acryl-based polymer may contain a monomer unit or units derived from a monomer or monomers other than the alkyl(meth)acrylate, the aromatic ring-containing polymerizable monomer, and the hydroxyl group-containing monomer and other than any carboxyl group-containing monomer, as long as the objects of the present invention can be achieved. The other monomer unit or units preferably constitute less than 10% by weight, more preferably less than 5% by weight of the monomer units of the (meth)acryl-based polymer. It is particularly preferred that the (meth)acryl-based polymer consists essentially of monomer units derived from the alkyl(meth)acrylate, the aromatic ring-containing polymerizable monomer, and the hydroxyl group-containing monomer.

In the present invention, the (meth)acryl-based polymer needs to have a weight average molecular weight of 300,000 or more. The (meth)acryl-based polymer preferably has a weight average molecular weight of 500,000 or more, more preferably 650,000 or more. If its weight average molecular weight is less than 300,000, a pressure-sensitive adhesive layer with low durability can be formed, or a pressure-sensitive adhesive layer with low cohesive strength can be formed, which can easily cause adhesive residue. On the other hand, its weight average molecular weight needs to be 1,200,000 or less. Its weight average molecular weight is preferably 1,000,000 or less, more preferably 950,000 or less. If its weight average molecular weight does not fall within the range of 300,000 to 1,200,000, bonding ability or adhesive strength can be reduced. In such a case, the pressure-sensitive adhesive composition may also have too high viscosity in a solution system and thus may be difficult to apply. As used herein, the term “weight average molecular weight” refers to a polystyrene-equivalent weight average molecular weight, which is determined using gel permeation chromatography (GPC).

The (meth)acryl-based polymer may be produced by any method appropriately selected from known production methods such as solution polymerization, bulk polymerization, emulsion polymerization, and various types of radical polymerization. The resulting (meth)acryl-based polymer may be in any form, such as a random copolymer, a block copolymer, or a graft copolymer.

In solution polymerization, for example, ethyl acetate, toluene, or the like may be used as a polymerization solvent. An example of solution polymerization includes performing the reaction under a stream of inert gas such as nitrogen in the presence of a polymerization initiator typically under the reaction conditions of a temperature of about 50 to about 70° C. and a time period of about 5 to about 30 hours.

Any appropriately selected polymerization initiator, chain transfer agent, emulsifier, or other agents may be used for radical polymerization. The weight average molecular weight of the (meth)acryl-based polymer can be adjusted by controlling the amount of the polymerization initiator or the chain transfer agent or by controlling the reaction conditions. The amount of these agents may be adjusted as appropriate depending on the type of these agents.

Examples of the polymerization initiator include, but are not limited to, azo initiators such as 2,2′-azobisisobutyronitrile, 2,2′-azobis(2-amidinopropan)dihydrochloride, 2,2′-azobis[2-(5-methyl-2-imidazoline-2-yl)propan]dihydroch loride, 2,2′-azobis(2-methylpropionamidine)disulfate, 2,2′-azobis(N,N′-dimethyleneisobutylamidine), and 2,2′-azobis[N-(2-carboxyethyl)-2-methylpropionamidine]hydra to (VA-057 manufactured by Wako Pure Chemical Industries, Ltd.); persulfates such as potassium persulfate and ammonium persulfate; peroxide initiators such as di(2-ethylhexyl) peroxydicarbonate, di(4-tert-butylcyclohexyl) peroxydicarbonate, di-sec-butyl peroxydicarbonate, tert-butyl peroxyneodecanoate, tert-hexyl peroxypivalate, tert-butyl peroxypivalate, dilauroyl peroxide, di-n-octanoyl peroxide, 1,1,3,3-tetramethylbutylperoxy-2-ethyl hexanoate, di(4-methylbenzoyl) peroxide, dibenzoyl peroxide, tert-butyl peroxyisobutyrate, 1,1-di(tert-hexylperoxy)cyclohexane, tert-butyl hydroperoxide, and hydrogen peroxide; and a redox system initiator including a combination of a peroxide and a reducing agent, such as a combination of a persulfate and sodium hydrogen sulfite or a combination of a peroxide and sodium ascorbate.

The above polymerization initiators may be used alone or in combination of two or more. The total content of the polymerization initiator(s) is preferably from about 0.005 to about 1 part by weight, more preferably from about 0.02 to about 0.5 parts by weight, based on 100 parts by weight of the monomers.

For example, when the (meth)acryl-based polymer having a weight average molecular weight as stated above is produced using 2,2′-azobisisobutyronitrile as a polymerization initiator, the amount of the polymerization initiator is preferably from about 0.06 to about 0.2 parts by weight, more preferably from about 0.08 to about 0.175 parts by weight, based on 100 parts by weight of all monomers.

Examples of the chain transfer agent include lauryl mercaptan, glycidyl mercaptan, mercaptoacetic acid, 2-mercaptoethanol, thioglycolic acid, 2-ethylhexyl thioglycolate, and 2,3-dimercapto-1-propanol. The chain transfer agents may be used alone or in combination of two or more. The total content of the chain transfer agent(s) should be about 0.1 parts by weight or less, based on 100 parts by weight of all monomers.

Examples of the emulsifier for use in emulsion polymerization include anionic emulsifiers such as sodium lauryl sulfate, ammonium lauryl sulfate, sodium dodecylbenzenesulfonate, ammonium polyoxyethylene alkyl ether sulfate, and sodium polyoxyethylene alkyl phenyl ether sulfate; and nonionic emulsifiers such as polyoxyethylene alkyl ether, polyoxyethylene alkyl phenyl ether, polyoxyethylene fatty acid ester, and polyoxyethylene-polyoxypropylene block polymers. These emulsifiers may be used alone or in combination of two or more.

The emulsifier may be a reactive emulsifier. Examples of such an emulsifier having an introduced radically-polymerizable functional group, such as a propenyl group or an allyl ether group, include AQUALON HS-10, HS-20, KH-10, BC-05, BC-10, and BC-20 (all manufactured by DAI-ICHI KOGYO SEIYAKU CO., LTD.) and ADEKA REASOAP SE10N (manufactured by ADEKA CORPORATION). The reactive emulsifier is preferred, because after polymerization, it can improve water resistance by being incorporated in the polymer chain. Based on 100 parts by weight of all monomers, the emulsifier is preferably used in an amount of 0.3 to 5 parts by weight, more preferably 0.5 to 1 part by weight, in view of polymerization stability or mechanical stability.

The pressure-sensitive adhesive composition of the present invention for use on an optical film preferably contains a radical generating agent in addition to the (meth)acryl-based polymer. When the (meth)acryl-based polymer has a relatively low molecular weight, the product obtained by radically crosslinking the (meth)acryl-based polymer with a radical generating agent tends to have high durability and properties close to those of a high-molecular-weight polymer with a high inter-crosslink molecular weight, as compared with the product obtained by crosslinking the (meth)acryl-based polymer with an agent reactive with the functional group of the polymer, such as diisocyanate. It is not clear why the product obtained by radically crosslinking the (meth)acryl-based polymer with a radical generating agent has high durability. However, the following grounds can be considered.

To keep the durability of a pressure-sensitive adhesive composed mainly of a low-molecular-weight (meth)acryl-based polymer, it is generally proposed that the pressure-sensitive adhesive should be hardened by isocyanate crosslinking or the like. In this case, the polymer structure can easily form a three-dimensional network structure after the crosslinking, because crosslinkable sites such as hydroxyl group-containing monomer sites are randomly arranged in polymer chains of the low-molecular-weight (meth)acryl-based polymer. Such a polymer structure can have hard physical properties but cannot easily have flexibility at a level typical of high-molecular-weight polymers. Thus, there is a problem in that defects such as peeling can easily occur especially in the process of laminating such a pressure-sensitive adhesive layer on a highly expandable/shrinkable substrate such as a polarizing plate. To solve this problem, it is considered preferable that the low-molecular-weight (meth)acryl-based polymer should be selectively terminated with a reactive site (functional group) for crosslinking such as a hydroxyl group so that the polymer chains can be linked to form long strands in the pressure-sensitive adhesive layer when a crosslinked structure is formed. However, there is some technical difficulty in producing a functional group-terminated (meth)acryl-based polymer, and such a polymer is also not preferred in view of productivity in some cases. On the other hand, when the (meth)acryl-based polymer is radically crosslinked using a radical generating agent, the polymer terminals can be easily crosslinked, and the crosslinked product tends to have properties close to those of a high-molecular-weight polymer with a high inter-crosslink molecular weight. Thus, after radically crosslinked with a radical generating agent, the (meth)acryl-based polymer can be highly elastic and flexible like a high-molecular-weight polymer with a high inter-crosslink molecular weight and can have high durability.

The radical generating agent for use in the present invention may be any compound capable of generating radicals upon exposure to heat or active energy rays. For example, the radical generating agent may be a peroxide.

Any peroxide capable of generating active radical species upon heating and capable of crosslinking the base polymer in the pressure-sensitive adhesive composition can be used appropriately. In view of workability or stability, a peroxide with a one-minute half-life temperature of 80° C. to 160° C. is preferably used, and a peroxide with a one-minute half-life temperature of 90° C. to 140° C. is more preferably used.

Examples of peroxides that can be used in the present invention include di(2-ethylhexyl) peroxydicarbonate (one-minute half-life temperature: 90.6° C.), di(4-tert-butylcyclohexyl) peroxydicarbonate (one-minute half-life temperature: 92.1° C.), di-sec-butyl peroxydicarbonate (one-minute half-life temperature: 92.4° C.), tert-butyl peroxyneodecanoate (one-minute half-life temperature: 103.5° C.), tert-hexyl peroxypivalate (one-minute half-life temperature: 109.1° C.), tert-butyl peroxypivalate (one-minute half-life temperature: 110.3° C.), dilauroyl peroxide (one-minute half-life temperature: 116.4° C.), di-n-octanoyl peroxide (one-minute half-life temperature: 117.4° C.), 1,1,3,3-tetramethylbutylperoxy-2-ethyl hexanoate (one-minute half-life temperature: 124.3° C.), di(4-methylbenzoyl) peroxide (one-minute half-life temperature: 128.2° C.), dibenzoyl peroxide (one-minute half-life temperature: 130.0° C.), tert-butyl peroxyisobutyrate (one-minute half-life temperature: 136.1° C.), and 1,1-di(tert-hexylperoxy)cyclohexane (one-minute half-life temperature: 149.2° C.). In particular, di(4-tert-butylcyclohexyl) peroxydicarbonate (one-minute half-life temperature: 92.1° C.), dilauroyl peroxide (one-minute half-life temperature: 116.4° C.), and dibenzoyl peroxide (one-minute half-life temperature: 130.0° C.) are preferably used because they can provide higher crosslinking reaction efficiency.

The half life of a peroxide, which is an indicator of how fast the peroxide can be decomposed, refers to the time required for the remaining amount of the peroxide to reach one half of the original amount. The decomposition temperature required for a certain half life and the half life time obtained at a certain temperature are shown in catalogs furnished by manufacturers, such as Organic Peroxide Catalog, 9th Edition, May, 2003 furnished by NOF CORPORATION.

These peroxides may be used alone or in combination of two or more. When a peroxide is used for the crosslinking treatment, radicals should be effectively produced for the crosslinking reaction with no peroxide residue. As a guide, therefore, the crosslinking temperature and the crosslinking time should be set so that 50% or more, preferably 75% or more of the peroxide will be decomposed. If the degree of decomposition of the peroxide is low, a large part of the peroxide will remain, which is not preferred because the crosslinking reaction can be prolonged. More specifically, for example, if the crosslinking temperature corresponds to the one-minute half-life temperature, the degree of decomposition will be 50% after 1 minute and 75% after 2 minutes, which means that the heat treatment should be performed for 1 minute or more. If the peroxide has a half-life time of 30 seconds at the crosslinking temperature, the crosslinking treatment should be performed for 30 seconds or more. If the peroxide has a half-life time of 5 minutes at the crosslinking temperature, the crosslinking treatment should be performed for 5 minutes or more. As described above, the crosslinking temperature and the crosslinking time, which depend on the peroxide to be used, can be adjusted by proportional calculation from its half-life time, assuming that the degree of decomposition of the peroxide is linearly proportional to time. Because of the risk of side reactions, however, the heat treatment should be performed at a temperature of up to 170° C. It will be understood that the temperature during drying may be directly used for the heat treatment or the heat treatment may be performed after drying. The treatment time may be from 0.2 to 20 minutes, preferably from 0.5 to 10 minutes, which is determined taking into account productivity or workability. The amount of decomposition of the peroxide can be determined by a method of measuring the peroxide residue after the reaction process, such as by high performance liquid chromatography (HPLC).

More specifically, for example, after the reaction process, about 0.2 g of each pressure-sensitive adhesive composition is taken out and immersed in 10 ml of ethyl acetate and subjected to shaking extraction at 25° C. and 120 rpm for 3 hours in a shaker, and then allowed to stand at room temperature for 3 days. Subsequently, 10 ml of acetonitrile is added, and the mixture is shaken at 25° C. and 120 rpm for 30 minutes. About 10 μl of the liquid extract obtained by filtration through a membrane filter (0.45 μm) is subjected to HPLC by injection and analyzed so that the amount of the peroxide after the reaction process is determined.

Based on 100 parts by weight of the base polymer, a peroxide may be used in an amount of 0.05 parts by weight or more, preferably 0.07 parts by weight or more, and may be used in an amount of 2 parts by weight or less, preferably 1 part by weight or less. Within such a range, the crosslinking reaction can be sufficiently performed to provide high durability while excessive crosslinking can be prevented, and a composition with high tackiness can be obtained. Thus, such a range is preferred.

A photo-crosslinking agent may also be used as the radical generating agent. The photo-crosslinking agent is a crosslinking agent capable of causing a crosslinking reaction under the action of rays of light, such as rays of sunlight, laser beams, infrared rays, visible rays, ultraviolet rays, X rays, or other radiations (electromagnetic waves). Hydroxyketones, benzyl dimethyl ketals, aminoketones, acylphosphine oxide compounds, benzophenone compounds, trichloromethyl group-containing triazine derivatives, or other photo-crosslinking agents may be used. Examples of trichloromethyl group-containing triazine derivatives include 2-(p-methoxyphenyl)-4,6-bis-(trichloromethyl)-s-triazine, 2-phenyl-4,6-bis-(trichloromethyl)-s-triazine, 2-(4′-methoxy-1′-naphthyl)-4,6-bis-(trichloromethyl)-s-tria zine, 2,4-trichloromethyl-(4′-methoxyphenyl)-6-triazine, 2,4-trichloromethyl-(4′-methoxynaphthyl)-6-triazine, 2,4-trichloromethyl-(piperonyl)-6-triazine, and 2,4-trichloromethyl-(4′-methoxystyryl)-6-triazine. Oligomer type photo-crosslinking agents such as 2-hydroxy-2-methyl-[4-(1-methylvinyl)phenyl]propanol oligomers, oligomers formed by the polymerization of acrylated benzophenone,

1-[4-(2-hydroxyethoxy)phenyl]-2-hydroxy-2-methyl-1-propan-1-one, and oligomers formed by the polymerization of a reaction product between the primary hydroxyl group of photo-cleavable α-hydroxyphenyl ketone (e.g., Irgacure 2959 (trade name), Ciba Specialty Chemicals) and 2-isocyanatoethyl methacrylate are also highly cross-linkable and preferably used. These oligomer type photo-crosslinking agents preferably have a molecular weight of up to about 50,000, more preferably 1,000 to 50,000. If their molecular weight is higher than this limit, they may have low compatibility with the acryl-based polymer.

Among them, polyfunctional photo-crosslinking agents having two or more radical-generating sites per molecule can be used alone. A polyfunctional photo-crosslinking agent may also be used in combination with a monofunctional type photo-crosslinking agent.

The photo-crosslinking agent is preferably used in combination with a photosensitizer such as an acetophenone compound, a phosphine oxide compound, or an imidazole compound. The crosslinking can be efficiently performed using a photosensitizer.

Examples of an acetophenone compound include 4-diethylaminoacetophenone, 1-hydroxycyclohexyl phenyl ketone, 2-benzyl-2-dimethylamino-4′-morpholinobutyrophenone, 2-hydroxy-2-methyl-1-phenylpropan-1-one, and
2,2-dimethoxy-1,2-diphenylethan-1-one.

Examples of a phosphine oxide compound include phenylbis(2,4,6-trimethylbenzoyl)-phosphine oxide, 2,4,6-trimethylbenzoyldiphenylphosphine oxide, and 2,4,6-trimethylbenzoylphenylethoxyphosphine oxide.

Examples of an imidazole compound include 2-p-dimethylphenyl-4-phenyl-imidazole, 4,5-bis-p-biphenyl-imidazole, 2,2′-bis(2-methylphenyl)-4,4′,5,5′-tetraphenyl-1,2′-biimidazole, 2,2′-bis(2-chlorophenyl)-4,4′,5,5′-tetraphenyl-1,2′-biimidazole, 2,2′-bis(2,4-dichlorophenyl)-4,4′,5,5′-tetraphenyl-1,2′-bii midazole.

Based on 100 parts by weight of the alkyl(meth)acrylate, the pressure-sensitive adhesive composition of the present invention for use on an optical film may contain a radical generating agent in an amount of 0.02 parts by weight or more, preferably 0.05 parts by weight or more, and in an amount of 2 parts by weight or less, preferably 1 part by weight or less. Within such a range, the crosslinking reaction can be sufficiently performed to provide high durability while excessive crosslinking can be prevented, and a composition with high tackiness can be obtained. Thus, such a range is preferred.

The pressure-sensitive adhesive composition of the present invention for use on an optical film preferably contains an isocyanate crosslinking agent in addition to the (meth)acryl-based polymer. In this case, the hydroxyl groups of the polymer can be crosslinked through the isocyanate crosslinking agent, so that after the crosslinking reaction, the polymer can have a solvent-soluble component with a weight average molecular weight of 100,000 or more. Thus, the resulting pressure-sensitive adhesive would have good durability.

The term “isocyanate crosslinking agent” refers to a compound having two or more isocyanate groups (which may include functional groups that are temporarily protected with an isocyanate blocking agent or by oligomerization and are convertible to isocyanate groups) per molecule.

Isocyanate crosslinking agents include aromatic isocyanates such as tolylene diisocyanate and xylene diisocyanate, alicyclic isocyanates such as isophorone diisocyanate, and aliphatic isocyanates such as hexamethylene diisocyanate.

More specifically, examples of isocyanate crosslinking agents include lower aliphatic polyisocyanates such as butylene diisocyanate and hexamethylene diisocyanate; alicyclic isocyanates such as cyclopentylene diisocyanate, cyclohexylene diisocyanate, and isophorone diisocyanate; aromatic diisocyanates such as 2,4-tolylene diisocyanate, 4,4′-diphenylmethane diisocyanate, xylylene diisocyanate, and polymethylene polyphenyl isocyanate; isocyanate adducts such as a trimethylolpropane/tolylene diisocyanate trimer adduct (CORONATE L (trade name) manufactured by NIPPON POLYURETHANE INDUSTRY CO., LTD.), a trimethylolpropane/hexamethylene diisocyanate trimer adduct (CORONATE HL (trade name) manufactured by NIPPON POLYURETHANE INDUSTRY CO., LTD.), and an isocyanurate of hexamethylene diisocyanate (CORONATE HX (trade name) manufactured by NIPPON POLYURETHANE INDUSTRY CO., LTD.); polyether polyisocyanate and polyester polyisocyanate; adducts thereof with various polyols; and polyisocyanates polyfunctionalized with an isocyanurate bond, a biuret bond, an allophanate bond, or the like. In particular, aliphatic isocyanates are preferably used because of their high reaction speed. In applications requiring transparency, aliphatic or alicyclic isocyanates are preferably used rather than aromatic isocyanate compounds.

These isocyanate crosslinking agents may be used alone or in combination of two or more. The total content of the isocyanate compound crosslinking agent (s) is preferably from 0.01 to 5 parts by weight, more preferably from 0.05 to 3 parts by weight, even more preferably from 0.1 to 2 parts by weight, based on 100 parts by weight of the (meth)acryl-based polymer. If the content of the isocyanate compound crosslinking agent is more than 5 parts by weight, microgel can be easily produced to cause whitening of the coating liquid or the pressure-sensitive adhesive layer. On the other hand, if its content is too low, the ability to crosslink the (meth)acrylate polymer can be low, which may have an adverse effect on durability.

A polyfunctional metal chelate may also be used as the crosslinking agent in the pressure-sensitive adhesive composition of the present invention. The polyfunctional metal chelate may include a polyvalent metal and an organic compound that is covalently or coordinately bonded to the metal.

Examples of the polyvalent metal atom include Al, Cr, Zr, Co, Cu, Fe, Ni, V, Zn, In, Ca, Mg, Mn, Y, Ce, Sr, Ba, Mo, La, Sn, and Ti. The organic compound has a covalent or coordinate bond-forming atom such as an oxygen atom. Examples of the organic compound include an alkyl ester, an alcohol compound, an ether compound, and a ketone compound.

The pressure-sensitive adhesive composition of the present invention for use on an optical film preferably contains a reactive silyl group-containing silane compound in addition to the (meth)acryl-based polymer. The addition of such a silane compound can improve moisture resistance and suppress peeling. In the present invention, such a silane compound may be broadly classified into a “polyether compound” having a polyether skeleton and a “silane coupling agent” having a reactive silyl group and another reactive group than the reactive silyl group. A pressure-sensitive adhesive layer made from the pressure-sensitive adhesive composition containing a silane coupling agent has improved durability. When the composition contains a polyether compound, a pressure-sensitive adhesive layer made from the composition is characterized by having not only improved durability but also improved removability.

A polyether compound or a silane coupling agent may be used alone as the silane compound, or a polyether compound and a silane coupling agent may be used together as the silane compounds. A single polyether compound may be used, or two or more polyether compounds may be used together. The same applies to the silane coupling agent. The total content of the silane compound(s) may be from 0.01 to 1 part by weight, preferably from 0.02 to 0.6 parts by weight, based on 100 parts by weight of the (meth)acryl-based polymer. Within this range, the composition can have a satisfactory level of adhesive strength and removability, which is preferred.

The pressure-sensitive adhesive layer-carrying optical film may have a pressure-sensitive adhesive layer made from the pressure-sensitive adhesive composition for use on an optical film containing a polyether compound in addition to the (meth)acryl-based polymer. When the pressure-sensitive adhesive layer contains such a polyether compound, the advantageous effects described below can be produced. Specifically, after the pressure-sensitive adhesive layer-carrying optical film is bonded to a liquid crystal cell or other components, various processes may be performed over a long time, or the product may be stored at high temperature. Even in such a case, the adhesive strength to the liquid crystal cell or other components will not increase, and the pressure-sensitive adhesive layer-carrying optical film has high removability and thus can be easily peeled off from the liquid crystal cell or other components, so that the liquid crystal cell can be reused without damage or pollution. In particular, it has been difficult to peel off conventional pressure-sensitive adhesive layer-carrying optical films from large liquid crystal cells. According to the present invention, however, the pressure-sensitive adhesive layer-carrying optical film can be easily peeled off even from a large liquid crystal cell. The pressure-sensitive adhesive layer-carrying optical film of the present invention also has good durability on a variety of optical films (such as triacetylcellulose resins, (meth)acryl-based resins, or norbornene resins) and resists peeling, lifting, and other failures when bonded to a liquid crystal cell or other components.

The polyether compound may have a polyether skeleton and a reactive silyl group at at least one end, wherein the reactive silyl group is represented by general formula (1):

—SiRₐM₃₋ₐ (1)

In formula (1), R is a monovalent organic group having 1 to 20 carbon atoms and optionally having a substituent, M is a hydroxyl group or a hydrolyzable group, and a is an integer of 1 to 3. In the formula, two or more R groups, if any, may be the same or different, and two or more M groups, if any, may be the same or different.

This polyether compound has at least one reactive silyl group of the formula per molecule at its end. When the polyether compound is a straight-chain compound, it can have one or two reactive silyl groups of the formula at its ends, and preferably has two silyl groups of the formula at its ends. When the polyether compound is a branched-chain compound, it has not only main-chain ends but also side-chain ends, and it has at least one silyl group of the formula at at least one of these ends. It preferably has two or more silyl groups of the formula, more preferably three or more silyl groups of the formula, depending on the number of its ends.

The reactive silyl group-containing polyether compound may have the reactive silyl group at at least part of its molecular ends and also have at least one, preferably 1.1 to five, more preferably 1.1 to three reactive silyl groups in the middle of its molecule.

In the reactive silyl group represented by formula (1), R is a monovalent organic group having 1 to 20 carbon atoms and optionally having a substituent. R is preferably a straight- or branched-chain alkyl group of 1 to 8 carbon atoms, a fluoroalkyl group of 1 to 8 carbon atoms, or a phenyl group, more preferably an alkyl group of 1 to 6 carbon atoms, even more preferably a methyl group. If two or more R groups are present in the same molecule, they may be the same or different. M is a hydroxyl group or a hydrolyzable group. The hydrolyzable group is directly bonded to the silicon atom and can form a siloxane bond through a hydrolysis reaction and/or a condensation reaction. Examples of the hydrolyzable group include a halogen atom, an alkoxy group, an acyloxy group, an alkenyloxy group, a carbamoyl group, an amino group, an aminooxy group, and a ketoxymate group. When the hydrolyzable group has a carbon atom or atoms, the number of the carbon atoms is preferably 6 or less, more preferably 4 or less. In particular, an alkoxy or alkenyloxy group of 4 or less carbon atoms is preferred, and a methoxy group or an ethoxy group is particularly preferred. When two or more M groups are present in the same molecule, they may be the same or different.

The reactive silyl group represented by formula (1) is preferably an alkoxysilyl group represented by general formula (3):

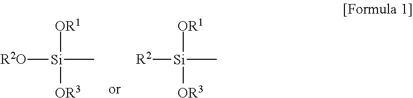

In formula (3), R¹, R², and R³ are each a monovalent hydrocarbon group of 1 to 6 carbon atoms and may be the same group or different groups in the same molecule.

Examples of R¹, R² and R³ in the alkoxysilyl group represented by formula (3) include a straight- or branched-chain alkyl group of 1 to 6 carbon atoms, a straight- or branched-chain alkenyl group of 2 to 6 carbon atoms, a cycloalkyl group of 5 to 6 carbon atoms, and a phenyl group. Specific examples of —OR¹, —OR², and —OR³ in the formula include a methoxy group, an ethoxy group, a propoxy group, a propenyloxy group, and a phenoxy group. Among them, a methoxy group and an ethoxy group are preferred, and a methoxy group is particularly preferred.

The polyether skeleton of the polyether compound preferably has a straight- or branched-chain oxyalkylene group of 1 to 10 carbon atoms as a repeating structural unit. The structural unit of the oxyalkylene group preferably has 2 to 6 carbon atoms, more preferably three carbon atoms. The repeating structural unit of the oxyalkylene group may be a repeating structural unit of a single oxyalkylene group or a repeating structural unit of two or more oxyalkylene groups arranged in block or random fashion. For example, the oxyalkylene group may be an oxyethylene group, an oxypropylene group, or an oxybutylene group. Among these oxyalkylene groups, an oxypropylene group (particularly —CH₂CH(CH₃)O—) is preferred as the structural unit, because of easiness of the production of the material or the stability of the material.

Preferably, the main chain of the polyether compound consists essentially of a polyether skeleton in addition to the reactive silyl group. In this context, “the main chain consisting essentially of a polyoxyalkylene chain” means that the main chain may contain a small amount of any other chemical structure. Concerning any other chemical structure, for example, when the repeating structural unit of the oxyalkylene group is produced to form the polyether skeleton, it may also contain the chemical structure of an initiator and a linking group or the like to the reactive silyl group. The content of the repeating structural unit of the oxyalkylene group of the polyether skeleton is preferably 50% by weight or more, more preferably 80% by weight or more, based on the total weight of the polyether compound.

The polyether compound may be a compound represented by general formula (2):

RₐM₃₋ₐSi—X—Y-(AO)ₙ—Z formula (2)

In formula (2), R is a monovalent organic group having 1 to 20 carbon atoms and optionally having a substituent, M is a hydroxyl group or a hydrolyzable group, and a is an integer of 1 to 3. In the formula, two or more R groups, if any, may be the same or different, and two or more M groups, if any, may be the same or different. AO is a straight- or branched-chain oxyalkylene group of 1 to 10 carbon atoms, and n is the average number of moles of the added oxyalkylene group and is from 1 to 1,700. X is a straight- or branched-chain alkylene group of 1 to 20 carbon atoms. Y is an ether bond, an ester bond, a urethane bond, or a carbonate bond.

Z is a hydrogen atom, a monovalent hydrocarbon group of 1 to 10 carbon atoms, or a group represented by general formula (2A):

—Y₁—X—SiRₐM₃₋ₐ

In formula (2A), R, M, and X have the same meanings as defined above. Y¹ is a single bond, a —CO— bond, a —CONH— bond, a —COO— bond, or a group represented by general formula (2B):

-Q{-(OA)ₙ-Y—X—SiRₐM₃₋ₐ}ₘ

In formula (2B), R, M, X, and Y have the same meanings as defined above. OA has the same meaning as AO defined above, and n has the same meaning as defined above. Q is a divalent or polyvalent hydrocarbon group of 1 to 10 carbon atoms, and m is a number that is the same as the valence of the hydrocarbon group.

In formula (2), X is a straight- or branched-chain alkylene group of 1 to 20 carbon atoms, preferably 2 to 10 carbon atoms, more preferably three carbon atoms.

In formula (2), Y is a linking group that may be formed by reaction with the terminal hydroxyl group of the oxyalkylene group of the polyether skeleton. Y is preferably an ether bond or a urethane bond, more preferably a urethane bond.

Z corresponds to a hydroxy compound having a hydroxyl group, which is involved as an initiator for the oxyalkylene polymer in the production of the compound represented by formula (2). When formula (2) has one reactive silyl group at one end, Z at the other end is a hydrogen atom or a monovalent hydrocarbon group of 1 to 10 carbon atoms. When Z is a hydrogen atom, the same structural unit as that of the oxyalkylene polymer is used for the hydroxy compound. When Z is a monovalent hydrocarbon group of 1 to 10 carbon atoms, the hydroxy compound used has one hydroxyl group.

When formula (2) has two or more reactive silyl groups at its ends, Z corresponds to formula (2A) or (2B). When Z corresponds to formula (2A), the same structural unit as that of the oxyalkylene polymer is used for the hydroxy compound. When Z corresponds to formula (2B), the hydroxy compound used differs from the structural unit of the oxyalkylene polymer and has two hydroxyl groups. When Z corresponds to formula (2A), Y¹ is a linking group that may be formed by reaction with the terminal hydroxyl group of the oxyalkylene group of the polyether skeleton as in the case of Y.

In view of removability, the polyether compound represented by formula (2) is preferably a compound represented by general formula (4):

Z⁰-A²-O-(A¹O)ₙ—Z¹

In formula (4), A¹O is an oxyalkylene group of 2 to 6 carbon atoms, n is the average number of moles of the added A¹O and is from 1 to 1,700. Z¹ is a hydrogen atom or -A²-Z⁰. A² is an alkylene group of 2 to 6 carbon atoms. The polyether compound represented by formula (2) is also preferably a compound represented by general formula (5):

Z⁰-A²-NHCOO-(A¹O)ₙ—Z²

In formula (5), A¹O is an oxyalkylene group of 2 to 6 carbon atoms, and n is the average number of moles of the added A¹O and is from 1 to 1,700. Z² is a hydrogen atom or —CONH-A²-Z⁰. A² is an alkylene group of 2 to 6 carbon atoms. The polyether compound represented by formula (2) is also preferably a compound represented by general formula (6):

Z³—O-(A¹O)ₙ—CH{—CH₂-(A¹O)ₙ—Z³}₂

In formula (6), A¹O is an oxyalkylene group of 2 to 6 carbon atoms, n is the average number of moles of the added A¹O and is from 1 to 1,700. Z³ is a hydrogen atom or -A²-Z⁰, and at least one of the Z³ groups is -A²-Z⁰. A² an alkylene group of 2 to 6 carbon atoms. In all of formulae (4), (5) and (6), Z⁰ is the alkoxysilyl group represented by formula (3). The oxyalkylene group for A¹O may be any of a straight chain and a branched chain, and in particular, it is preferably an oxypropylene group. The alkylene group for A² may be any of a straight chain and a branched chain, and in particular, it is preferably a propylene group.

The compound represented by formula (5) is preferably a compound represented by general formula (5A):

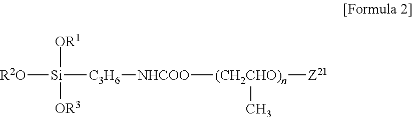

In formula (5A), R², R², and R³ are each a monovalent hydrocarbon group of 1 to 6 carbon atoms and may be the same group or different groups in the same molecule. In the formula, n is the average number of moles of the added oxypropylene group and is from 1 to 1,700.

Z²¹ is a hydrogen atom or a trialkoxysilyl group represented by general formula (5B):

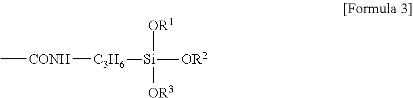

In formula (5B), R¹, R², and R³ have the same meanings as defined above.

In view of removability, the polyether compound preferably has a number average molecular weight of 300 to 100,000. The lower limit to the number average molecular weight is preferably 500 or more, more preferably 1,000 or more, even more preferably 2,000 or more, still more preferably 3,000 or more, further more preferably 4,000 or more, further more preferably 5,000 or more. The upper limit to the number average molecular weight is preferably 50,000 or less, more preferably 40,000 or less, even more preferably 30,000 or less, still more preferably 20,000 or less, further more preferably 10,000 or less. Preferred ranges of the number average molecular weight may be set using these upper and lower limits. In the polyether compound represented by formula (2), (4), (5), or (6), n is the average number of moles of the added oxyalkylene group in the polyether skeleton. The polyether compound is preferably controlled so as to have a number average molecular weight in the above range. When the polyether compound has a number average molecular weight of 1,000 or more, n is generally from 10 to 1,700.

The Mw (the weight average molecular weight)/Mn (the number average molecular weight) ratio of the polymer is preferably 3.0 or less, more preferably 1.6 or less, particularly preferably 1.5 or less. To produce a reactive silyl group-containing polyether compound with a lower Mw/Mn ratio, it is particularly preferred to use an oxyalkylene polymer obtained by polymerization of a cyclic ether in the presence of an initiator and especially a catalyst of the composite metal cyanide complex shown below. A method of modifying the end of such an oxyalkylene polymer material into a reactive silyl group is most preferred.

For example, the polyether compound represented by formula (2), (4), (5), or (6) may be produced by a process including using an oxyalkylene polymer having a functional group at the molecular end as a raw material and linking a reactive silyl group to the molecular end through an organic group such as an alkylene group. The oxyalkylene polymer used as a raw material is preferably a hydroxyl-terminated polymer obtained by ring-opening polymerization reaction of a cyclic ether in the presence of a catalyst and an initiator.

The initiator to be used may be a compound having one or more active hydrogen atoms per molecule, such as a hydroxy compound having one or more hydroxyl groups per molecule. For example, the initiator may be a hydroxyl group-containing compound such as ethylene glycol, propylene glycol, dipropylene glycol, butanediol, hexamethylene glycol, hydrogenated bisphenol A, neopentyl glycol, polybutadiene glycol, diethylene glycol, triethylene glycol, polyethylene glycol, allyl alcohol, methallyl alcohol, glycerin, trimethylolmethane, trimethylolpropane, pentaerythritol, or an alkylene oxide adduct of any of these compounds. These initiators may be used alone or in combination of two or more.

A polymerization catalyst may be used in the ring-opening polymerization of a cyclic ether in the presence of the initiator. Examples of the polymerization catalyst include alkali metal compounds such as potassium compounds such as potassium hydroxide and potassium methoxide and cesium compounds such as cesium hydroxide; composite metal cyanide complexes; metalloporphyrin complexes; and P═N bond-containing compounds.

In the polyether compound represented by formula (2), (4), (5), or (6), the polyoxyalkylene chain preferably includes a polymerized unit of oxyalkylene formed by ring-opening polymerization of an alkylene oxide of 2 to 6 carbon atoms. The polyoxyalkylene chain more preferably includes a repeating structural unit of an oxyalkylene group formed by ring-opening polymerization of at least one alkylene oxide selected from the group consisting of ethylene oxide, propylene oxide, and butylene oxide. The polyoxyalkylene chain even more preferably includes a repeating structural unit of oxyalkylene formed by ring-opening polymerization of propylene oxide. When the polyoxyalkylene chain includes two or more oxyalkylene group repeating structural units, the two or more oxyalkylene group repeating structural units may be arranged in block or random fashion.

For example, the polyether compound represented by formula (5) may be obtained by urethane-forming reaction between a polymer having a polyoxyalkylene chain and a hydroxyl group and a compound having the reactive silyl group represented by formula (1) and an isocyanate group. An alternative method may also be used in which the reactive silyl group represented by formula (1) is introduced to a molecular end using an addition reaction of hydrosilane or mercaptosilane to the unsaturated group of an unsaturated group-containing oxyalkylene polymer such as an allyl-terminated polyoxypropylene monool obtained by polymerization of alkylene oxide with allyl alcohol as an initiator.

The reactive silyl group represented by formula (1) may be introduced to the end group of a hydroxyl-terminated oxyalkylene polymer (also referred to as “oxyalkylene polymer material”) obtained by ring-opening polymerization of a cyclic ether in the presence of an initiator. Examples of such a method of introducing the reactive silyl group include, but are not limited to, the methods (a), (b) and (c) described below in which the reactive silyl group is generally linked to the end group through an additional organic group.

(a) A method including introducing an unsaturated group to the end of an oxyalkylene polymer material having a hydroxyl group and then linking the reactive silyl group to the unsaturated group. Examples of this method may include the two methods (a-1) and (a-2) described below. (a-1) A method of allowing a hydrosilyl compound to react with the unsaturated group in the presence of a catalyst such as a platinum compound (a method using what is called hydrosilylation reaction). (a-2) A method of allowing a mercaptosilane compound to react with the unsaturated group. Examples of the mercaptosilane compound include 3-mercaptopropyltrimethoxysilane, 3-mercaptopropyltriethoxysilane, 3-mercaptopropyltriisopropenyloxysilane, 3-mercaptopropylmethyldimethoxysilane, 3-mercaptopropyldimethylmonomethoxysilane, and 3-mercaptopropylmethyldiethoxysilane.

The reaction between the unsaturated group and the mercapto group may be performed using a compound such as a radical generating agent for use as a radical polymerization initiator. If desired, the reaction may be performed using radiation or heat with no radical polymerization initiator. Examples of the radical polymerization initiator include peroxide-type, azo-type, and redox-type polymerization initiators, and metal compound catalysts, and specific examples thereof include 2,2′-azobisisobutyronitrile, 2,2′-azobis-2-methylbutyronitrile, benzoyl peroxide, tert-alkyl peroxyester, acetyl peroxide, and diisopropyl peroxycarbonate. The reaction between the unsaturated group and the mercapto group in the presence of a radical polymerization initiator is preferably performed for several hours to several tens of hours at a reaction temperature of generally 20 to 200° C., preferably 50 to 150° C., depending on the decomposition temperature (half-life temperature) of the polymerization initiator.

A method of introducing an unsaturated group to the end of the oxyalkylene polymer material may include allowing the oxyalkylene polymer material to react with a reactant having both an unsaturated group and a functional group capable of forming a bond, such as an ether bond, an ester bond, a urethane bond, or a carbonate bond, with the terminal hydroxyl group of the oxyalkylene polymer material. An alternative method may also be used in which an unsaturated group-containing epoxy compound such as allyl glycidyl ether is copolymerized in the process of polymerizing a cyclic ether in the presence of an initiator, so that the unsaturated group is introduced to at least part of the ends of the oxyalkylene polymer material. The method is preferably performed at a temperature of 60 to 120° C. In general, the hydrosilylation reaction can sufficiently proceed in a reaction time of several hours or less.

(b) A method of allowing the oxyalkylene polymer material having a hydroxyl group at its end to react with an isocyanate silane compound having a reactive silyl group. Examples of such an isocyanate silane compound include 1-isocyanatomethyltrimethoxysilane, 1-isocyanatomethyltriethoxysilane, 1-isocyanatopropyltrimethoxysilane, 1-isocyanatopropyltriethoxysilane, 3-isocyanatopropyltrimethoxysilane, 3-isocyanatopropyltriethoxysilane, 1-isocyanatomethylmethyldimethoxysilane, 1-isocyanatomethyldimethylmonomethoxysilane, 1-isocyanatomethylmethyldiethoxysilane, 1-isocyanatopropylmethyldimethoxysilane, 1-isocyanatopropyldimethylmonomethoxysilane, 1-isocyanatopropylmethyldiethoxysilane, 3-isocyanatopropylmethyldimethoxysilane, 3-isocyanatopropyldimethylmonomethoxysilane, and 3-isocyanatopropylmethyldiethoxysilane. Among these compounds, 3-isocyanatopropyltrimethoxysilane and 1-isocyanatomethylmethyldimethoxysilane are more preferred, and 3-isocyanatopropyltrimethoxysilane is particularly preferred.

The reaction is preferably performed at a molar ratio (NCO/OH) of the isocyanate group (NCO) of the isocyanate silane compound to the hydroxyl group (OH) of the oxyalkylene polymer material of 0.80 to 1.05. This method has a small number of production steps and thus makes it possible to significantly reduce the process time. This method produces no by-product impurities during the process and thus does not need a complicated operation such as purification. The ratio (NCO/OH (molar ratio)) of the NCO group to the OH group is more preferably from 0.85 to 1.00. If the NCO ratio is too low, the remaining OH group may react with the reactive silyl group, so that the storage stability may be at an undesirable level. In such a case, it is preferred that the isocyanate silane compound or a monoisocyanate compound should be newly allowed to react so that the excessive part of the OH groups can be consumed and the silylation rate can be adjusted to the desired level.

A known urethane-forming reaction catalyst may also be used in the reaction between the hydroxyl group of the oxyalkylene polymer material and the isocyanate silane compound. The reaction temperature and the reaction time required until the reaction is completed vary with the presence or absence and the amount of the urethane-forming reaction catalyst. In general, the reaction is preferably performed at a temperature of 20 to 200° C., more preferably 50 to 150° C., for several hours.

(c) A method including allowing the oxyalkylene polymer having a hydroxyl group at the molecular end to react with a polyisocyanate compound under isocyanate group-excess conditions to produce an oxyalkylene polymer having an isocyanate group at at least part of the ends and further allowing the isocyanate group to react with a functional group-containing silicon compound. The functional group of the silicon compound is an active hydrogen-containing group selected from the group consisting of a hydroxyl group, a carboxyl group, a mercapto group, a primary amino group, and a secondary amino group. Examples of the silicon compound include aminosilane compounds such as N-phenyl-3-aminopropyltrimethoxysilane, 3-aminopropyltrimethoxysilane, 3-aminopropyltriethoxysilane, N-phenyl-3-aminopropylmethyldimethoxysilane, 3-aminopropylmethyldimethoxysilane, and 3-aminopropylmethyldiethoxysilane; and mercaptosilane compounds such as 3-mercaptopropyltrimethoxysilane and 3-mercaptopropylmethyldimethoxysilane. A known urethane-forming reaction catalyst may also be used in the reaction of the functional group-containing silicon compound with the hydroxyl and isocyanate groups of the oxyalkylene polymer material. The reaction temperature and the reaction time required until the reaction is completed vary with the presence or absence and the amount of the urethane-forming reaction catalyst. In general, the reaction is preferably performed at a temperature of 20 to 200° C., more preferably 50 to 150° C., for several hours.

Specific examples of the polyether compound include MS Polymers S203, S303 and S810 manufactured by Kaneka Corporation; SILYL EST250 and EST280 manufactured by Kaneka Corporation; SAT10, SAT200, SAT220, SAT350, and SAT400 manufactured by Kaneka Corporation; and EXCESTAR S2410, S2420 or S3430 manufacture by ASAHI GLASS CO., LTD.

Particularly when the pressure-sensitive adhesive layer contains the polyether compound, the content of the polyether compound in the pressure-sensitive adhesive composition is preferably 0.001 to 20 parts by weight based on 100 parts by weight of the (meth)acryl-based polymer (A). If the content of the polyether compound is less than 0.001 parts by weight, the effect of improving removability may be insufficient. The content of the polyether compound is preferably 0.01 parts by weight or more, more preferably 0.02 parts by weight or more, even more preferably 0.1 parts by weight or more, still more preferably 0.5 parts by weight or more. On the other hand, if the content of the polyether compound is more than 20 parts by weight, moisture resistance may be insufficient, and peeling may be more likely to occur in a reliability test. The content of the polyether compound is preferably 10 parts by weight or less, more preferably 5 parts by weight or less, even more preferably 3 parts by weight or less. Preferred ranges of the polyether compound content may be set using these upper and lower limits. Although preferred ranges of the polyether compound content are shown above, the polyether compound can be advantageously used in an amount of 1 part by weight or less or in an amount of 0.5 parts by weight or less.

The pressure-sensitive adhesive composition of the present invention for use on an optical film may contain a silane coupling agent in addition to the (meth)acryl-based polymer. The term “silane coupling agent” means a reactive group-containing silane compound. Examples of such a silane compound include epoxy group-containing silane coupling agents such as 3-glycidoxypropyltrimethoxysilane, 3-glycidoxypropylmethyldiethoxysilane, and 2-(3,4-epoxycyclohexyl)ethyltrimethoxysilane; amino group-containing silane coupling agents such as 3-aminopropyltrimethoxysilane, N-2-(aminoethyl)-3-aminopropylmethyldimethoxysilane, 3-triethoxysilyl-N-(1,3-dimethyl-butylidene)propylamine, and N-phenylaminopropyltrimethoxysilane; (meth)acrylic group-containing silane coupling agents such as 3-acryloxypropyltrimethoxysilane and 3-methacryloxypropyltriethoxysilane; and isocyanate group-containing silane coupling agents such as 3-isocyanatopropyltriethoxysilane.

The pressure-sensitive adhesive composition containing the components described above is adjusted to have a solid content of 20% by weight or more and a solvent content of 80% by weight or less. The pressure-sensitive adhesive composition preferably has a solid content of 20 to 50% by weight and a solvent content of 50 to 80% by weight, more preferably a solid content of 20 to 40% by weight and a solvent content of 60 to 80% by weight, even more preferably a solid content of 25 to 35% by weight and a solvent content of 65 to 75% by weight. Although any type of solvent may be used in the composition, ethyl acetate, toluene, or other solvents used for the polymerization of the base polymer are preferably used. The composition preferably has a viscosity of 1 to 12 Pa·s, more preferably 2 to 9 Pa·s, even more preferably 4 to 7 Pa·s, as measured at 23° C. and 100 rpm with a Brookfield type viscometer. Specifically, the composition of the present invention is in the form of a solution. If the viscosity of the pressure-sensitive adhesive composition is too high, streaks or uneven coating can easily occur, and if it is too low, air bubbles can be easily trapped. In both cases, appearance defects may occur after the coating process. In addition, the pressure-sensitive adhesive composition having a viscosity within the above range can be stably applied by commonly used roll coating, kiss roll coating, gravure coating, reverse coating, roll brush coating, spray coating, dip roll coating, bar coating, knife coating, air knife coating, curtain coating, lip coating, or extrusion coating with a die coater or the like without forming rough surfaces, and in this case, the amount of the solvent can also be reduced. In the present invention, the pressure-sensitive adhesive composition is preferably applied using a die coater, more preferably using a die coater with a fountain die or a slot die.

The crosslinking agent assists the formation of a pressure-sensitive adhesive layer. When a pressure-sensitive adhesive layer is formed, the total amount of the crosslinking agent to be added should be adjusted, and the effect of the crosslinking temperature and the crosslinking time should be carefully taken into account.

In the production of the pressure-sensitive adhesive layer, the gel fraction of the crosslinked pressure-sensitive adhesive layer is preferably adjusted to 40 to 90% by weight, more preferably 47 to 85% by weight, even more preferably 50 to 80% by weight.

The gel fraction can be adjusted to a predetermined value by controlling the amount of addition of the isocyanate crosslinking agent or the photo-crosslinking agent taking into account the effect of the light irradiation dose.

After the crosslinking reaction, the solvent-soluble component may have a weight average molecular weight Mw of 100,000 or more, preferably 120,000 or more, more preferably 150,000 or more. When the solvent-soluble component has an Mw of 100,000 or more, the pressure-sensitive adhesive layer will have good durability.

The pressure-sensitive adhesive composition of the present invention may further contain other known additives as long as such additives do not produce microgel. Examples of such additives include powders of colorants, pigments or the like, dyes, surfactants, plasticizers, tackifiers, surface lubricants, leveling agents, softening agents, antioxidants, age resisters, light stabilizers, ultraviolet absorbers, polymerization inhibitors, inorganic or organic fillers, metal powders, and particulate or flaky materials, which may be added as appropriate depending on the intended use.

The pressure-sensitive adhesive-carrying optical member of the present invention includes an optical member and a pressure-sensitive adhesive layer placed on at least one side of the optical member and made from the pressure-sensitive adhesive.

For example, the pressure-sensitive adhesive layer can be formed by a method including applying the pressure-sensitive adhesive composition to a release-treated separator or the like, removing the polymerization solvent and the like from the composition by drying, crosslinking the composition to form a pressure-sensitive adhesive layer, and then transferring the pressure-sensitive adhesive layer onto an optical member. Alternatively, the pressure-sensitive adhesive layer can be formed by a method including applying the pressure-sensitive adhesive composition to an optical member, removing the polymerization solvent and the like from the composition by drying, and crosslinking the composition to form a pressure-sensitive adhesive layer on the optical member. In the process of applying the pressure-sensitive adhesive, if necessary, one or more solvents other than the polymerization solvent may be newly added to the composition.

A silicone release liner is preferably used as the release-treated separator. The adhesive composition of the present invention may be applied to such a liner and dried to form a pressure-sensitive adhesive layer. In this process, any appropriate method may be used for drying the pressure-sensitive adhesive, depending on the purpose. Preferably, a method of heating and drying the coating film is used. The heating and drying temperature is preferably from 40° C. to 200° C., more preferably from 50° C. to 180° C., even more preferably from 70° C. to 170° C. When the heating temperature is set within the range, a pressure-sensitive adhesive with a high level of adhesive properties can be obtained.

Any appropriate drying time may be used as needed. The drying time is preferably from 5 seconds to 20 minutes, more preferably from 5 seconds to 10 minutes, even more preferably from 10 seconds to 5 minutes.

The surface of the optical member may also be coated with an anchor layer or subjected to any of various adhesion-facilitating treatments such as a corona treatment and a plasma treatment, before the pressure-sensitive adhesive layer is formed. The surface of the pressure-sensitive adhesive layer may also be subjected to an adhesion-facilitating treatment.

Various methods may be used to form the pressure-sensitive adhesive layer. Specific examples of such methods include roll coating, kiss roll coating, gravure coating, reverse coating, roll brush coating, spray coating, dip roll coating, bar coating, knife coating, air knife coating, curtain coating, lip coating, and extrusion coating with a die coater or the like. In particular, a die coater is preferably used, and a die coater with a fountain die or a slot die is more preferably used.

The thickness of the pressure-sensitive adhesive layer is typically, but not limited to, about 2 to about 500 μm. It is preferably 5 to 100 μm, more preferably 5 to 50 μm.

In the present invention, radiation may be used in the crosslinking and/or curing process. Examples of radiation include, but not limited to, infrared rays, visible rays, ultraviolet rays, X rays, and other rays such as electron beams. Among them, ultraviolet rays are particularly preferred. When irradiated with radiation, the pressure-sensitive adhesive composition of the present invention can be used with no need for producing an inert gas atmosphere or placing an oxygen-blocking cover film on the coating, so that working efficiency will be high.

For example, when ultraviolet rays are used, the UV dose is generally from about 20 mJ/cm² to about 10 J/cm², preferably from about 1 J/cm² to 5 J/cm², although it may be appropriately determined depending on the type of the polymer or the photo-crosslinking agent used. The ultraviolet irradiation may be performed using a low-pressure mercury lamp, a high-pressure mercury lamp, an extra-high pressure mercury lamp, a metal halide lamp, a chemical lamp, a black light lamp, a mercury-xenon lamp, an excimer lamp, a short arc lamp, a helium-cadmium laser, an argon laser, an excimer laser, or sunlight as an irradiation light source. In particular, a low-pressure mercury lamp, an extra-high pressure mercury lamp, or a metal halide lamp is preferably used.

The ultraviolet wavelength is preferably from 200 to 500 nm, more preferably from 250 to 480 nm, even more preferably from 300 to 480 nm although it may be appropriately selected depending on the desired degree of crosslinking. The dose of these ultraviolet rays is indicated by the total dose of UVA (320 to 390 nm), UVB (280 to 320 nm), UVC (250 to 260 nm), and UVV (395 to 445 nm) as measured with UV Power Puck (manufactured by EIT Inc).

The temperature during the irradiation is preferably, but not limited to, about 140° C. or less, taking into account the heat resistance of the support.

The pressure-sensitive adhesive layer may be exposed. In such a case, the pressure-sensitive adhesive layer may be protected by a release-treated sheet (separator) until it is actually used.

Examples of the material used to form such a separator include a plastic film such as a polyethylene, polypropylene, polyethylene terephthalate, or polyester film, a porous material such as paper, fabric, or nonwoven fabric, and appropriate thin materials such as a net, a foamed sheet, a metal foil, and a laminate thereof. A plastic film is advantageously used because of its good surface smoothness.

Such a plastic film may be of any type capable of protecting the pressure-sensitive adhesive layer. For example, such a plastic film may be a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, or an ethylene-vinyl acetate copolymer film.

The separator generally has a thickness of about 5 to about 200 μm, preferably about 5 to about 100 μm. If necessary, the separator may be subjected to a release treatment and an anti-pollution treatment with a silicone, fluoride, long-chain alkyl, or fatty acid amide release agent, silica powder or the like, or subjected to an antistatic treatment of coating type, kneading and mixing type, vapor-deposition type, or the like. In particular, when the surface of the separator is appropriately subjected to a release treatment such as a silicone treatment, a long-chain alkyl treatment, or a fluorine treatment, the releasability from the pressure-sensitive adhesive layer can be further improved.

The release-treated sheet used in the preparation of the pressure-sensitive adhesive-type optical member may be used by itself as a separator for the pressure-sensitive adhesive-type optical member, so that the process can be simplified.

The optical member may be of any type used to form an image display device such as a liquid crystal display device. For example, the optical member may be a polarizing plate. The polarizing plate generally used includes a polarizer and a transparent protective film or films provided on one or both sides of the polarizer.

Any of various polarizers may be used without restriction. For example, the polarizer may be a product produced by a process including adsorbing a dichroic material such as iodine or a dichroic dye to a hydrophilic polymer film such as a polyvinyl alcohol-based film, a partially-formalized polyvinyl alcohol-based film, or a partially-saponified, ethylene-vinyl acetate copolymer-based film and uniaxially stretching the film or may be a polyene-based oriented film such as a film of a dehydration product of polyvinyl alcohol or a dehydrochlorination product of polyvinyl chloride. In particular, a polarizer including a polyvinyl alcohol-based film and a dichroic material such as iodine is advantageous. The thickness of the polarizer is generally, but not limited to, about 80 μm or less.

For example, a polarizer including a uniaxially-stretched polyvinyl alcohol-based film dyed with iodine may be produced by a process including immersing a polyvinyl alcohol film in an aqueous iodine solution to dye the film and stretching the film to 3 to 7 times the original length. If necessary, the polyvinyl alcohol-based film may be immersed in an aqueous solution of potassium iodide or the like optionally containing boric acid, zinc sulfate, zinc chloride, or the like. If necessary, the polyvinyl alcohol-based film may be further immersed in water for washing before it is dyed. If the polyvinyl alcohol-based film is washed with water, dirt and any anti-blocking agent can be cleaned from the surface of the polyvinyl alcohol-based film, and the polyvinyl alcohol-based film can also be allowed to swell so that unevenness such as uneven dyeing can be effectively prevented. The film may be stretched before, while, or after it is dyed with iodine. The film may also be stretched in an aqueous solution of boric acid, potassium iodide, or the like or in a water bath.

A thin polarizer with a thickness of 10 μm or less may also be used. In view of thickness reduction, the thickness is preferably from 1 to 7 μm. Such a thin polarizer is less uneven in thickness, has good visibility, and is less dimensionally-variable and thus has high durability. It is also preferred because it can form a thinner polarizing plate.

Typical examples of such a thin polarizer include the thin polarizing films disclosed in JP-A-51-069644, JP-A-2000-338329, WO2010/100917, PCT/JP2010/001460, Japanese Patent Application No. 2010-269002, and Japanese Patent Application No. 2010-263692. These thin polarizing films can be obtained by a process including the steps of stretching a laminate of a polyvinyl alcohol-based resin (hereinafter also referred to as PVA-based resin) layer and a stretchable resin substrate and dyeing the laminate. Using this process, the PVA-based resin layer, even when thin, can be stretched without problems such as breakage, which would otherwise be caused by stretching of the layer supported on a stretchable resin substrate.

Among processes including the steps of stretching and dyeing a laminate, a process capable of achieving high-ratio stretching to improve polarizing performance is preferably used when the thin polarizing film is formed. Thus, the thin polarizing film is preferably obtained by a process including the step of stretching in an aqueous boric acid solution as disclosed in WO2010/100917, PCT/JP2010/001460, Japanese Patent Application No. 2010-269002, or Japanese Patent Application No. 2010-263692, and more preferably obtained by a process including the step of performing auxiliary in-air stretching before stretching in an aqueous boric acid solution as disclosed in Japanese Patent Application No. 2010-269002 or 2010-263692.

PCT/JP2010/001460 discloses a thin highly-functional polarizing film that is formed integrally with a resin substrate, made of a PVA-based resin containing an oriented dichroic material, and has a thickness of 7 μm or less and the optical properties of a single transmittance of 42.0% or more and a degree of polarization of 99.95% or more.

This thin highly-functional polarizing film can be produced by a process including forming a PVA-based resin coating on a resin substrate with a thickness of at least 20 μm, drying the coating to form a PVA-based resin layer, immersing the resulting PVA-based resin layer in a dyeing liquid containing a dichroic material to adsorb the dichroic material to the PVA-based resin layer, and stretching the PVA-based resin layer, which contains the adsorbed dichroic material, together with the resin substrate in an aqueous boric acid solution to a total stretch ratio of 5 times or more the original length.

A laminated film including a thin highly-functional polarizing film containing an oriented dichroic material can be produced by a method including the steps of: applying a PVA-based resin-containing aqueous solution to one side of a resin substrate with a thickness of at least 20 μm, drying the coating to form a PVA-based resin layer so that a laminated film including the resin substrate and the PVA-based resin layer formed thereon is produced; immersing the laminated film in a dyeing liquid containing a dichroic material to adsorb the dichroic material to the PVA-based resin layer in the laminated film, wherein the laminated film includes the resin substrate and the PVA-based resin layer formed on one side of the resin substrate; and stretching the laminated film, which has the PVA-based resin layer containing the adsorbed dichroic material, in an aqueous boric acid solution to a total stretch ratio of 5 times or more the original length, wherein the PVA-based resin layer containing the adsorbed dichroic material is stretched together with the resin substrate, so that a laminated film including the resin substrate and a thin highly-functional polarizing film formed on one side of the resin substrate is produced, in which the thin highly-functional polarizing film is made of the PVA-based resin layer containing the oriented dichroic material and has a thickness of 7 μm or less and the optical properties of a single transmittance of 42.0% or more and a degree of polarization of 99.95% or more.
Japanese Patent Application No. 2010-269002 or 2010-263692.

The thin polarizing film disclosed in Japanese Patent Application No. 2010-269002 or 2010-263692 is a polarizing film in the form of a continuous web including a PVA-based resin containing an oriented dichroic material, which is made with a thickness of 10 μm or less by a two-stage stretching process including auxiliary in-air stretching of a laminate and stretching of the laminate in an aqueous boric acid solution, wherein the laminate includes an amorphous ester-based thermoplastic resin substrate and a PVA-based resin layer formed thereon. This thin polarizing film is preferably made to have optical properties satisfying the following requirements: P>−(100.929T−42.4-1)×100 (provided that T<42.3) and P≧99.9 (provided that T≧42.3), wherein T represents the single transmittance, and P represents the degree of polarization.

Specifically, the thin polarizing film can be produced by a thin polarizing film-manufacturing method including the steps of: performing elevated temperature in-air stretching of a PVA-based resin layer, so that a stretched intermediate product including an oriented PVA-based resin layer is produced, wherein the PVA-based resin layer is formed on an amorphous ester-based thermoplastic resin substrate in the form of a continuous web; adsorbing a dichroic material (which is preferably iodine or a mixture of iodine and an organic dye) to the stretched intermediate product to produce a colored intermediate product including the PVA-based resin layer in which the dichroic material is oriented; and performing stretching of the colored intermediate product in an aqueous boric acid solution so that a polarizing film with a thickness of 10 μm or less is produced, which includes the PVA-based resin layer containing the oriented dichroic material.

In this manufacturing method, the elevated temperature in-air stretching and the stretching in an aqueous boric acid solution are preferably performed in such a manner that the PVA-based resin layer formed on the amorphous ester-based thermoplastic resin substrate is stretched to a total stretch ratio of 5 times or more. The aqueous boric acid solution preferably has a temperature of 60° C. or more for the stretching therein. Before stretched in the aqueous boric acid solution, the colored intermediate product is preferably subjected to an insolubilization treatment, in which the colored intermediate product is preferably immersed in an aqueous boric acid solution with a temperature of 40° C. or less. The amorphous ester-based thermoplastic resin substrate may be made of amorphous polyethylene terephthalate including co-polyethylene terephthalate in which isophthalic acid, cyclohexanedimethanol, or any other monomer is copolymerized, and the amorphous ester-based thermoplastic resin substrate is preferably made of a transparent resin. The thickness of the substrate may be at least seven times the thickness of the PVA-based resin layer to be formed. The elevated temperature in-air stretching is preferably performed at a stretch ratio of 3.5 times or less, and the temperature of the elevated temperature in-air stretching is preferably equal to or higher than the glass transition temperature of the PVA-based resin. Specifically, it is preferably in the range of 95° C. to 150° C. When the elevated temperature in-air stretching is end-free uniaxial stretching, the PVA-based resin layer formed on the amorphous ester-based thermoplastic resin substrate is preferably stretched to a total stretch ratio of from 5 to 7.5 times. When the elevated temperature in-air stretching is fixed-end uniaxial stretching, the PVA-based resin layer formed on the amorphous ester-based thermoplastic resin substrate is preferably stretched to a total stretch ratio of from 5 to 8.5 times.

More specifically, the thin polarizing film can be produced by the method described below.

A substrate in the form of a continuous web is prepared, which is made of co-polyethylene terephthalate (amorphous PET) containing 6 mol % of copolymerized isophthalic acid. The amorphous PET has a glass transition temperature of 75° C. A laminate of a polyvinyl alcohol (PVA) layer and the amorphous PET substrate in the form of a continuous web is prepared as described below. Incidentally, the glass transition temperature of PVA is 80° C.

A 200-μm-thick amorphous PET substrate is provided, and an aqueous 4-5% PVA solution is prepared by dissolving PVA powder with a polymerization degree of 1,000 or more and a saponification degree of 99% or more in water. Subsequently, the aqueous PVA solution is applied to a 200-μm-thick amorphous PET substrate and dried at a temperature of 50 to 60° C. so that a laminate composed of the amorphous PET substrate and a 7-μm-thick PVA layer formed thereon is obtained.

The laminate having the 7-μm-thick PVA layer is subjected to a two-stage stretching process including auxiliary in-air stretching and stretching in an aqueous boric acid solution as described below, so that a thin highly-functional polarizing film with a thickness of 3 μm is obtained. At the first stage, the laminate having the 7-μm-thick PVA layer is subjected to an auxiliary in-air stretching step so that the layer is stretched together with the amorphous PET substrate to form a stretched laminate having a 5-μm-thick PVA layer. Specifically, the stretched laminate is formed by a process including feeding the laminate having the 7 μm thick PVA layer to a stretching apparatus placed in an oven with the stretching temperature environment set at 130° C. and subjecting the laminate to end-free uniaxial stretching to a stretch ratio of 1.8 times. In the stretched laminate, the PVA layer is modified, by the stretching, into a 5-μm-thick PVA layer containing oriented PVA molecules.

Subsequently, a dyeing step is performed to produce a colored laminate having a 5-μm-thick PVA layer containing oriented PVA molecules and adsorbed iodine. Specifically, the colored laminate is produced by immersing the stretched laminate for a certain period of time in a dyeing liquid containing iodine and potassium iodide and having a temperature of 30° C. so that iodine can be adsorbed to the PVA layer of the stretched laminate and so that the PVA layer for finally forming a highly-functional polarizing film can have a single transmittance of 40 to 44%. In this step, the dyeing liquid contains water as a solvent and has an iodine concentration in the range of 0.12 to 0.30% by weight and a potassium iodide concentration in the range of 0.7 to 2.1% by weight. The concentration ratio of iodine to potassium iodide is 1:7. It should be noted that potassium iodide is necessary to make iodine soluble in water. More specifically, the stretched laminate is immersed for 60 seconds in a dyeing liquid containing 0.30% by weight of iodine and 2.1% by weight of potassium iodide, so that a colored laminate is produced, in which the 5-μm-thick PVA layer contains oriented PVA molecules and adsorbed iodine.

At the second stage, the colored laminate is further subjected to a stretching step in an aqueous boric acid solution so that the layer is further stretched together with the amorphous PET substrate to form an optical film laminate having a 3-μm-thick PVA layer, which forms a highly-functional polarizing film. Specifically, the optical film laminate is formed by a process including feeding the colored laminate to a stretching apparatus placed in a treatment system in which an aqueous boric acid solution containing boric acid and potassium iodide is set in the temperature range of 60 to 85° C. and subjecting the laminate to end-free uniaxial stretching to a stretch ratio of 3.3 times. More specifically, the aqueous boric acid solution has a temperature of 65° C. In the solution, the boric acid content and the potassium iodide content are 4 parts by weight and 5 parts by weight, respectively, based on 100 parts by weight of water. In this step, the colored laminate having a controlled amount of adsorbed iodine is first immersed in the aqueous boric acid solution for 5 to 10 seconds. Subsequently, the colored laminate is directly fed between a plurality of pairs of rolls different in peripheral speed, which form the stretching apparatus placed in the treatment system, and subjected to end-free uniaxial stretching for 30 to 90 seconds to a stretch ratio of 3.3 times. This stretching treatment converts the PVA layer of the colored laminate to a 3-μm-thick PVA layer in which the adsorbed iodine forms a polyiodide ion complex highly oriented in a single direction. This PVA layer forms a highly-functional polarizing film in the optical film laminate.

A cleaning step, which is however not essential for the manufacture of the optical film laminate, is preferably performed, in which the optical film laminate is taken out of the aqueous boric acid solution, and boric acid deposited on the surface of the 3-μm-thick PVA layer formed on the amorphous PET substrate is washed off with an aqueous potassium iodide solution. Subsequently, the cleaned optical film laminate is dried in a drying step using warm air at 60° C. It should be noted that the cleaning step is to prevent appearance defects such as boric acid precipitation.

A lamination and/or transfer step, which is also not essential for the manufacture of the optical film laminate, may also be performed, in which an 80-μm-thick triacetylcellulose film is laminated to the surface of the 3-μm-thick PVA layer formed on the amorphous PET substrate, while an adhesive is applied to the surface, and then the amorphous PET substrate is peeled off, so that the 3-μm-thick PVA layer is transferred to the 80-μm-thick triacetylcellulose film.

[Other Steps]

The thin polarizing film-manufacturing method may include additional steps other than the above steps. For example, additional steps may include an insolubilization step, a crosslinking step, a drying step (moisture control), etc. Additional steps may be performed at any appropriate timing.

The insolubilization step is typically achieved by immersing the PVA-based resin layer in an aqueous boric acid solution. The insolubilization treatment can impart water resistance to the PVA-based resin layer. The concentration of boric acid in the aqueous boric acid solution is preferably from 1 to 4 parts by weight based on 100 parts by weight of water. The insolubilization bath (aqueous boric acid solution) preferably has a temperature of 20° C. to 50° C. Preferably, the insolubilization step is performed after the preparation of the laminate and before the dyeing step or the step of stretching in water.

The crosslinking step is typically achieved by immersing the PVA-based resin layer in an aqueous boric acid solution. The crosslinking treatment can impart water resistance to the PVA-based resin layer. The concentration of boric acid in the aqueous boric acid solution is preferably from 1 to 4 parts by weight based on 100 parts by weight of water. When the crosslinking step is performed after the dyeing step, an iodide is preferably added to the solution. The addition of an iodide can suppress the elution of adsorbed iodine from the PVA-based resin layer. The amount of the addition of an iodide is preferably from 1 to 5 parts by weight based on 100 parts by weight of water. Examples of the iodide include those listed above. The temperature of the crosslinking bath (aqueous boric acid solution) is preferably from 20° C. to 50° C. Preferably, the crosslinking step is performed before the second stretching step in the aqueous boric acid solution. In a preferred embodiment, the dyeing step, the crosslinking step, and the second stretching step in the aqueous boric acid solution are performed in this order.

The material used to form the transparent protective film is typically thermoplastic resin with a high level of transparency, mechanical strength, thermal stability, water blocking properties, isotropy, etc. Specific examples of such thermoplastic resin include cellulose resin such as triacetylcellulose, polyester resin, polyethersulfone resin, polysulfone resin, polycarbonate resin, polyamide resin, polyimide resin, polyolefin resin, (meth)acrylic resin, cyclic polyolefin resin (norbornene resin), polyarylate resin, polystyrene resin, polyvinyl alcohol resin, and any blend thereof. The transparent protective film may be bonded to one side of the polarizer with an adhesive layer. In this case, thermosetting or ultraviolet-curable resin such as (meth)acrylic, urethane, acrylic urethane, epoxy, or silicone resin may be used to form a transparent protective film on the other side. The transparent protective film may contain any one or more appropriate additives. Examples of such an additive include an ultraviolet absorber, an antioxidant, a lubricant, a plasticizer, a release agent, an anti-discoloration agent, a flame retardant, a nucleating agent, an antistatic agent, a pigment, and a colorant. The content of the thermoplastic resin in the transparent protective film is preferably from 50 to 100% by weight, more preferably from 50 to 99% by weight, even more preferably from 60 to 98% by weight, still more preferably from 70 to 97% by weight. If the content of the thermoplastic resin in the transparent protective film is less than 50% by weight, high transparency and other properties inherent in the thermoplastic resin may be insufficiently exhibited.

The transparent protective film may also be the polymer film disclosed in JP-A-2001-343529 (WO01/37007), such as a film of a resin composition containing (A) a thermoplastic resin having a substituted and/or unsubstituted imide group in the side chain and (B) a thermoplastic resin having a substituted and/or unsubstituted phenyl and nitrile groups in the side chain. A specific example includes a film of a resin composition containing an alternating copolymer of isobutylene and N-methylmaleimide and an acrylonitrile-styrene copolymer. Films such as those produced by mixing and extruding the resin composition may be used. These films have a small retardation and a small photoelastic coefficient and thus can prevent polarizing plates from having defects such as strain-induced unevenness. They also have low water-vapor permeability and thus have high moisture resistance.

The thickness of the transparent protective film may be determined as appropriate. Its thickness is generally from about 1 to about 500 μm in view of strength, workability such as handleability, thin layer formability, or the like. In particular, its thickness is preferably from 1 to 300 μm, more preferably from 5 to 200 μm. The transparent protective film with a thickness of 5 to 150 μm is particularly preferred.

When transparent protective films are provided on both sides of the polarizer, protective films made of the same polymer material or different polymer materials may be used on the front and back sides.

In the present invention, at least one selected from cellulose resin, polycarbonate resin, cyclic polyolefin resin, and (meth)acrylic resin is preferably used to form the transparent protective film.

Cellulose resin is an ester of cellulose and a fatty acid. Specific examples of such a cellulose ester resin include triacetylcellulose, diacetyl cellulose, tripropionyl cellulose, dipropionyl cellulose, etc. Among them, triacetylcellulose is particularly preferred. Triacetylcellulose has many commercially available sources and is advantageous in view of easy availability and cost. Examples of commercially available products of triacetylcellulose include UV-50, UV-80, SH-80, TD-80U, TD-TAC, and UZ-TAC (trade names) manufactured by Fujifilm Corporation, and KC series manufactured by KONICA MINOLTA. In general, these triacetylcellulose products have a thickness direction retardation (Rth) of about 60 nm or less, while having an in-plane retardation (Re) of almost zero.

For example, cellulose resin films with a relatively small thickness direction retardation can be obtained by processing any of the above cellulose resins. Examples of the processing method include a method that includes laminating a common cellulose-based film to a base film, such as a polyethylene terephthalate, polypropylene, or stainless steel film, coated with a solvent such as cyclopentanone or methyl ethyl ketone, drying the laminate by heating (for example, at 80 to 150° C. for about 3 to about 10 minutes), and then peeling off the base film; and a method that includes coating a common cellulose resin film with a solution of a norbornene resin, a (meth)acrylic resin or the like in a solvent such as cyclopentanone or methyl ethyl ketone, drying the coated film by heating (for example, at 80 to 150° C. for about 3 to about 10 minutes), and then peeling off the coating.

The cellulose resin film with a relatively small thickness direction retardation to be used may be a fatty acid cellulose resin film with a controlled degree of fat substitution. Triacetylcellulose for general use has a degree of acetic acid substitution of about 2.8. Preferably, however, the degree of acetic acid substitution should be controlled to be from 1.8 to 2.7 so that the Rth can be reduced. The Rth can also be controlled to be low by adding a plasticizer such as dibutyl phthalate, p-toluenesulfonanilide, or acetyl triethyl citrate to the fatty acid-substituted cellulose resin. The plasticizer is preferably added in an amount of 40 parts by weight or less, more preferably 1 to 20 parts by weight, even more preferably 1 to 15 parts by weight, to 100 parts by weight of the fatty acid cellulose resin.

For a specific example, the cyclic polyolefin resin is preferably a norbornene resin. Cyclic olefin resin is a generic name for resins produced by polymerization of cyclic olefin used as a polymerizable unit, and examples thereof include the resins disclosed in JP-A-01-240517, JP-A-03-14882, and JP-A-03-122137. Specific examples thereof include ring-opened (co)polymers of cyclic olefins, addition polymers of cyclic olefins, copolymers (typically random copolymers) of cyclic olefin and α-olefin such as ethylene or propylene, graft polymers produced by modification thereof with unsaturated carboxylic acids or derivatives thereof, and hydrides thereof. Specific examples of the cyclic olefin include norbornene monomers.

Cyclic polyolefin resins have various commercially available sources. Specific examples thereof include ZEONEX (trade name) and ZEONOR (trade name) series manufactured by ZEON CORPORATION, ARTON (trade name) series manufactured by JSR Corporation, TOPAS (trade name) series manufactured by Ticona, and APEL (trade name) series manufactured by Mitsui Chemicals, Inc.

The (meth)acrylic resin preferably has a glass transition temperature (Tg) of 115° C. or more, more preferably 120° C. or more, even more preferably 125° C. or more, still more preferably 130° C. or more. If the Tg is 115° C. or more, the resulting polarizing plate can have high durability. The upper limit to the Tg of the (meth)acrylic resin is preferably, but not limited to, 170° C. or less, in view of formability or the like. The (meth)acrylic resin can form a film with an in-plane retardation (Re) of almost zero and a thickness direction retardation (Rth) of almost zero.

Any appropriate (meth)acrylic resin may be used as long as the effects of the present invention are not impaired. Examples of such a (meth)acrylic resin include poly(meth)acrylate such as poly(methyl methacrylate), methyl methacrylate-(meth)acrylic acid copolymers, methyl methacrylate-(meth)acrylic ester copolymers, methyl methacrylate-acrylic ester-(meth)acrylic acid copolymers, methyl(meth)acrylate-styrene copolymers (such as MS resins), and alicyclic hydrocarbon group-containing polymers (such as methyl methacrylate-cyclohexyl methacrylate copolymers and methyl methacrylate-norbornyl(meth)acrylate copolymers). Poly(C1 to C6 alkyl(meth)acrylate) such as poly(methyl(meth)acrylate) is preferred. A methyl methacrylate-based resin composed mainly of a methyl methacrylate unit (50 to 100% by weight, preferably 70 to 100% by weight) is more preferred.

Specific examples of the (meth)acrylic resin include ACRYPET VH and ACRYPET VRL20A each manufactured by MITSUBISHI RAYON CO., LTD., and the (meth)acrylic resins disclosed in JP-A-2004-70296 including (meth)acrylic resins having a ring structure in their molecule, and high-Tg (meth)acrylic resins obtained by intramolecular crosslinking or intramolecular cyclization reaction.

Lactone ring structure-containing (meth)acrylic resins may also be used as the (meth)acrylic resin. This is because they have high heat resistance and high transparency and also have high mechanical strength after biaxially stretched.

Examples of the lactone ring structure-containing (meth)acrylic reins include the lactone ring structure-containing (meth)acrylic reins disclosed in JP-A-2000-230016, JP-A-2001-151814, JP-A-2002-120326, JP-A-2002-254544, and JP-A-2005-146084.

The lactone ring structure-containing (meth)acrylic reins preferably have a ring-like structure represented by the following general formula (formula 6):

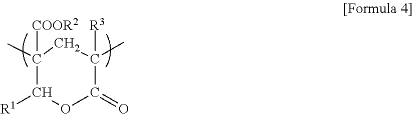

In the formula, R¹, R², and R³ each independently represent a hydrogen atom or an organic residue of 1 to 20 carbon atoms. The organic residue may contain an oxygen atom(s).

The content of the lactone ring structure represented by the general formula (formula 6) in the lactone ring structure-containing (meth)acrylic resin is preferably from 5 to 90% by weight, more preferably from 10 to 70% by weight, even more preferably from 10 to 60% by weight, still more preferably from 10 to 50% by weight. If the content of the lactone ring structure represented by the general formula (formula 6) in the lactone ring structure-containing (meth)acrylic resin is less than 5% by weight, the resin may have an insufficient level of heat resistance, solvent resistance, or surface hardness. If the content of the lactone ring structure represented by the general formula (formula 6) in the lactone ring structure-containing (meth)acrylic resin is more than 90% by weight, the resin may have low formability or workability.

The lactone ring structure-containing (meth)acrylic resin preferably has a mass average molecular weight (also referred to as “weight average molecular weight”) of 1,000 to 2,000,000, more preferably 5,000 to 1,000,000, even more preferably 10,000 to 500,000, still more preferably 50,000 to 500,000. Mass average molecular weights outside the above range are not preferred in view of formability or workability.

The lactone ring structure-containing (meth)acrylic resin preferably has a Tg of 115° C. or more, more preferably 120° C. or more, even more preferably 125° C. or more, still more preferably 130° C. or more. For example, if a transparent protective film made of such a resin with a Tg of 115° C. or more is incorporated into a polarizing plate, the polarizing plate will have high durability. The upper limit to the Tg of the lactone ring structure-containing (meth)acrylic resin is preferably, but not limited to, 170° C. or less, in view of formability or other properties.

An injection-molded product of the lactone ring structure-containing (meth)acrylic resin preferably has a total light transmittance as high as possible, preferably of 85% or more, more preferably of 88% or more, even more preferably of 90% or more, as measured by the method according to ASTM-D-1003. The total light transmittance is a measure of transparency, and a total light transmittance of less than 85% may mean lower transparency.

Before coated with an adhesive, the transparent protective film may be subjected to a surface modification treatment for improving its bondability to the polarizer. Specific examples of such a treatment include a corona treatment, a plasma treatment, a flame treatment, an ozone treatment, a primer treatment, a glow treatment, a saponification treatment, and a treatment with a coupling agent. An antistatic layer may also be formed as needed.

The surface of the transparent protective film, opposite to its surface where the polarizer is to be bonded, may be subjected to hard coating, an antireflection treatment, an anti-sticking treatment, or a treatment for diffusion or anti-glare purpose.

The surface treatment film may also be provided on and bonded to a front face plate. Examples of the surface treatment film include a hard-coat film for use in imparting scratch resistance to the surface, an anti-glare treatment film for preventing glare on image display devices, and an anti-reflection film such as an anti-reflective film or a low-reflective film, etc. The front face plate is provided on and bonded to the surface of an image display device such as a liquid crystal display device, an organic EL display device, a CRT, or a PDP to protect the image display device or to provide a high-grade appearance or a differentiated design. The front face plate is also used as a support for a λ/4 plate in a 3D-TV. In a liquid crystal display device, for example, the front face plate is provided above a polarizing plate on the viewer side. When the pressure-sensitive adhesive layer according to the present invention is used, the same effect can be produced using a plastic base material such as a polycarbonate or poly(methyl methacrylate) base material for the front face plate, as well as using a glass base material.

The optical film including a laminate of the polarizing plate and the optical layer may be formed by a method of stacking them one by one in the process of manufacturing a liquid crystal display device or the like. However, an optical film formed by previous lamination has the advantage that it can facilitate the process of manufacturing a liquid crystal display device or the like, because it has stable quality and good assembling workability. In the lamination, any appropriate bonding means such as a pressure-sensitive adhesive layer may be used. When the polarizing plate and any other optical layer are bonded together, their optical axes may be each aligned at an appropriate angle, depending on the desired retardation properties or other desired properties.

The pressure-sensitive adhesive layer-carrying optical film according to the present invention is preferably used to form a variety of image display devices such as liquid crystal display devices. Liquid crystal display devices may be formed according to conventional techniques. Specifically, a liquid crystal display device may be typically formed using any conventional technique including properly assembling a display panel such as a liquid crystal cell, a pressure-sensitive adhesive layer-carrying optical film, and optional components such as lighting system components, and incorporating a driving circuit, except that the pressure-sensitive adhesive layer-carrying optical film used is according to the present invention. The liquid crystal cell to be used may also be of any type such as TN type, STN type, π type, VA type, or IPS type.

Any desired liquid crystal display device may be formed, such as a liquid crystal display device including a display panel such as a liquid crystal cell and the pressure-sensitive adhesive layer-carrying optical film or films placed on one or both sides of the display panel or a liquid crystal display device further including a backlight or a reflector in a lighting system. In such a case, the optical film or films according to the present invention may be placed on one or both sides of a display panel such as a liquid crystal cell. When the optical films are provided on both sides, they may be the same or different. The process of forming a liquid crystal display device may also include placing an appropriate component such as a diffusion plate, an anti-glare layer, an anti-reflection film, a protective plate, a prism array, a lens array sheet, a light diffusion plate, or a backlight in one or more layers at an appropriate position or positions.

Next, an organic electroluminescence device (organic EL display device or OLED) will be described. An organic EL display device generally includes a transparent substrate and a light-emitting element (an organic electroluminescence light-emitting element) that is formed on the substrate by stacking a transparent electrode, an organic light-emitting layer, and a metal electrode in this order. In this structure, the organic light-emitting layer is a laminate of different organic thin films. Concerning such a laminate, various combinations are known, such as a laminate of a hole injection layer including a triphenylamine derivative or the like and a light-emitting layer including a fluorescent organic solid material such as anthracene, a laminate of such a light-emitting layer and an electron injection layer including a perylene derivative or the like, and a laminate of the hole injection layer, the light-emitting layer, and the electron injection layer.

The organic EL display device emits light based on the mechanism that holes and electrons are injected into the organic light-emitting layer when a voltage is applied between the transparent electrode and the metal electrode, and the energy generated by the recombination of the holes and the electrons excites the fluorescent substance, so that light is emitted when the excited fluorescent substance goes back to the ground state. The mechanism of the recombination during the process is similar to that in common diodes. As expected from this feature, current and emission intensity exhibit strong nonlinearity accompanied by rectification with respect to applied voltages.

In the organic EL display device, at least one of the electrodes must be transparent for the output of the emission from the organic light-emitting layer, and a transparent electrode made of a transparent electrical conductor such as indium tin oxide (ITO) is generally used as an anode. On the other hand, to facilitate the electron injection and increase the luminous efficiency, it is important to use a low-work-function substance for the cathode, and an electrode of a metal such as Mg—Ag or Al—Li is generally used.

In the organic EL display device with such a structure, the organic light-emitting layer is formed of a very thin film with a thickness of about 10 nm. Thus, light is almost entirely transmitted through the organic light-emitting layer, as well as through the transparent electrode. In the off-state, therefore, light incident on the surface of the transparent substrate is transmitted through the transparent electrode and the organic light-emitting layer and reflected from the metal electrode to return to and exit from the surface of the transparent substrate, so that the screen of the organic EL display looks like a mirror surface when it is viewed from the outside.

An organic EL display device that includes an organic electroluminescence light-emitting element including an organic light-emitting layer for emitting light upon voltage application, a transparent electrode provided on the front side of the organic light-emitting layer, and a metal electrode provided on the back side of the organic light-emitting layer may also include a polarizing plate provided on the front side of the transparent electrode and a retardation plate provided between the transparent electrode and the polarizing plate.

The retardation plate and the polarizing plate act to polarize light that enters from the outside and is reflected from the metal electrode. Thus, their polarization action is effective in preventing the mirror surface of the metal electrode from being visible from the outside. Specifically, the retardation plate may include a quarter wavelength plate, and the angle between the polarization directions of the polarizing plate and the retardation plate may be set at π/4, so that the mirror surface of the metal electrode can be completely shielded.

Of external light incident on the organic EL display device, therefore, only a linearly polarized light component is transmitted by the polarizing plate. The linearly polarized light is generally turned into elliptically polarized light by the retardation plate. Particularly when the retardation plate is a quarter wavelength plate and when the angle between the polarization directions of the polarizing plate and the retardation plate is π/4, the linearly polarized light is turned into circularly polarized light.

The circularly polarized light is transmitted through the transparent substrate, the transparent electrode, and the organic thin film, reflected from the metal electrode, transmitted through the organic thin film, the transparent electrode, and the transparent substrate again, and turned into linearly polarized light again by the retardation plate. The linearly polarized light has a polarization direction orthogonal to that of the polarizing plate and thus cannot pass through the polarizing plate. As a result, the mirror surface of the metal electrode can be completely shielded.

As described above, in order to block mirror reflection, the organic EL panel of an organic EL display device may use an elliptically or circularly polarizing plate having a combination of a retardation plate and a polarizing plate with the pressure-sensitive adhesive layer interposed therebetween. Alternatively, without an elliptically or circularly polarizing plate directly bonded to an organic EL panel, a laminate formed by bonding an elliptically or circularly polarizing plate to a touch panel with the pressure-sensitive adhesive layer interposed therebetween may be used in an organic EL panel.

The present invention is applicable to various types of touch panel, such as optical, ultrasonic, capacitance, and resistive touch panels. A resistive touch panel includes a touch-side, touch panel-forming electrode plate having a transparent conductive thin film; and a display-side, touch panel-forming electrode plate having a transparent conductive thin film, wherein the electrode plates are opposed to each other with spacers interposed therebetween in such a manner that the transparent conductive thin films are opposed to each other. On the other hand, a capacitance touch panel generally includes a transparent conductive film that has a transparent conductive thin film in a specific pattern and is formed over the surface of a display unit. The pressure-sensitive adhesive layer-carrying optical film according to the present invention may be used on any of the touch side and the display side.

### EXAMPLES

Hereinafter, the present invention is more specifically described with reference to the examples, which however are not intended to limit the present invention. In each example, “parts” and “%” are all by weight. Unless otherwise specified below, the conditions for allowing to stand at room temperature are 23° C. and 65% RH in all cases.

[Measurement of Weight Average Molecular Weight of (Meth)Acryl-Based Polymer]

The weight average molecular weight and the degree of dispersion (weight average molecular weight/number average molecular weight) of each (meth)acryl-based polymer were determined using gel permeation chromatography (GPC).
Analyzer: HLC-8120GPC manufactured by TOSOH CORPORATION
Columns: G7000H_{XL}+GMH_{XL}+GMH_{XL} manufactured by TOSOH CORPORATION
Column size: each 7.8 mmφ×30 cm, 90 cm in total
Column temperature: 40° C.
Flow rate: 0.8 ml/minute
Injection volume: 100 μl
Eluent: tetrahydrofuran
Detector: differential refractometer (RI)
Standard sample: polystyrene

(Preparation of Polarizing Plate)

An 80-μm-thick polyvinyl alcohol film was stretched to 3 times between rollers different in velocity ratio, while it was dyed in a 0.3% iodine solution at 30° C. for 1 minute. The film was then stretched to a total stretch ratio of 6 times, while it was immersed in an aqueous solution containing 4% boric acid and 10% potassium iodide at 60° C. for 0.5 minutes. Subsequently, the film was cleaned by immersion in an aqueous solution containing 1.5% potassium iodide at 30° C. for 10 seconds, and then dried at 50° C. for 4 minutes to give a polarizer (25 μm in thickness). A 40-μm-thick triacetylcellulose film was bonded to the viewer side of the polarizer with a polyvinyl alcohol-based adhesive. A pressure-sensitive adhesive was applied to the polarizer, and a retardation plate made of a 33-μm-thick norbornene resin film (ZEONOR FILM ZD12 (trade name) manufactured by ZEON CORPORATION) was bonded as a transparent protective film to the pressure-sensitive adhesive-coated side of the polarizer, so that a polarizing plate X (99.995 in degree of polarization) was obtained.

### Production Example 1

### Preparation of Acryl-Based Polymer (A)

To a four-neck flask equipped with a stirring blade, a thermometer, a nitrogen gas introducing tube, and a condenser were added 85.8% by weight of butyl acrylate, 13.2% by weight of benzyl acrylate, 1 part of 4-hydroxybutyl acrylate, and 0.1 part of 2,2′-azobisisobutyronitrile as a polymerization initiator together with 100 parts of ethyl acetate. Nitrogen gas was introduced to replace the air while the mixture was gently stirred, and then a polymerization reaction was performed for 8 hours while the temperature of the liquid in the flask was kept at about 55° C., so that a solution of an acryl-based polymer (A) with a weight average molecular weight (Mw) of 750,000 was obtained (weight average molecular weight (Mw)/number average molecular weight (Mn)=4.1).

### Production Examples 2 to 10

Acryl-based polymers (B) to (J) were prepared as in Production Example 1, except that the type or content of the monomers used to form each acryl-based polymer and the molecular weight of each acryl-based polymer were changed as shown in Table 1.

TABLE 1

| | | Monomer composition (wt %) | | | | | | |
|---|---|---|---|---|---|---|---|---|
| | | BA | BzA | HBA | HEA | AA | Mw | Mw/Mn |
| Production Example 1 | Acryl-based polymer A | 85.8 | 13.2 | 1 | — | — | 750,000 | 4.1 |
| Production Example 2 | Acryl-based polymer B | 85.8 | 13.2 | 1 | — | — | 430,000 | 3.6 |
| Production Example 3 | Acryl-based polymer C | 85.8 | 13.2 | 1 | — | — | 950,000 | 3.7 |
| Production Example 4 | Acryl-based polymer D | 85.8 | 13.2 | — | 1 | — | 730,000 | 3.6 |
| Production Example 5 | Acryl-based polymer E | 80.8 | 13.2 | 1 | — | 5 | 700,000 | 3.2 |
| Production Example 6 | Acryl-based polymer F | 85.8 | 13.2 | 1 | — | — | 250,000 | 2.9 |
| Production Example 7 | Acryl-based polymer G | 85.8 | 13.2 | 1 | — | — | 2,200,000 | 3.5 |
| Production Example 8 | Acryl-based polymer H | 83.8 | 13.2 | 3 | — | — | 740,000 | 4.0 |
| Production Example 9 | Acryl-based polymer I | 81.8 | 13.2 | 5 | — | — | 760,000 | 3.8 |
| Production Example 10 | Acryl-based polymer J | 76.8 | 13.2 | 10 | — | — | 800,000 | 4.5 |

In Table 1, BA represents butyl acrylate, BzA benzyl acrylate, HBA 4-hydroxybutyl acrylate, HEA 2-hydroxyethyl acrylate, and AA acrylic acid.

### Example 1

(Preparation of Pressure-Sensitive Adhesive Composition)

Based on 100 parts of the solid in the acryl-based polymer (A) solution obtained in Production Example 1, 0.3 part of dibenzoyl peroxide (NYPER BMT (SV) manufactured by NOF CORPORATION), 1 part of an isocyanate crosslinking agent (CORONATE L manufactured by Nippon Polyurethane Industry Co., Ltd., tolylene diisocyanate adduct of trimethylolpropane), and 0.5 part of a polyether compound (Silyl SAT10 manufactured by Kaneka Corporation) were added to the acryl-based polymer (A) solution, so that an acryl-based pressure-sensitive adhesive composition of Example 1 (with a solid content of 20% by weight) was obtained.

(Formation of Pressure-Sensitive Adhesive Layer)

The resulting acryl-based pressure-sensitive adhesive composition A was then applied to one side of a 38-μm-thick, silicone-treated, polyethylene terephthalate (PET) film (MRF38 manufactured by Mitsubishi Chemical Polyester Film Co., Ltd.) so that a 23-μm-thick pressure-sensitive adhesive layer could be formed after drying. The applied composition was dried at 155° C. for 1 minute to form a pressure-sensitive adhesive layer.

(Preparation of Pressure-Sensitive Adhesive Layer-Carrying Polarizing Plate)

The silicone-treated PET film having the pressure-sensitive adhesive layer was transferred onto the transparent protective film side (retardation plate side) of the polarizing plate, so that a pressure-sensitive adhesive layer-carrying polarizing plate was obtained.

### Examples 2 to 13 and 15 to 17 and Comparative Examples 1 to 3

Acryl-based pressure-sensitive adhesive compositions of Examples 2 to 13 and 15 to 17 and Comparative Examples 1 to 3 were prepared as in Example 1, except that the acryl-based polymer type, the solid content, the additive type, and the amounts of the components were changed as shown in Table 2. As in Example 1, each acryl-based pressure-sensitive adhesive composition was then applied to one side of a 38-μm-thick, silicone-treated, polyethylene terephthalate (PET) film (MRF38 manufactured by Mitsubishi Chemical Polyester Film Co., Ltd.) so that a 23-μm-thick pressure-sensitive adhesive layer could be formed after drying, and the applied composition was dried at 155° C. for 1 minute to form a pressure-sensitive adhesive layer. The silicone-treated PET film having the pressure-sensitive adhesive layer was then transferred onto the transparent protective film side (retardation plate side) of each polarizing plate. Thus, pressure-sensitive adhesive layer-carrying polarizing plates of Examples 2 to 13 and 15 to 17 and Comparative Examples 1 to 3 were obtained.

### Example 14

(Preparation of Pressure-Sensitive Adhesive Layer-Carrying Polarizing Plate)

The same polarizing plate X (99.995 in degree of polarization) was used as in Example 1. A priming agent was applied, with a wire bar, to the transparent protective film side (retardation plate side) of the polarizing plate X, on which a pressure-sensitive adhesive layer was to be formed, so that a priming layer (100 nm in thickness) was formed. The priming agent used was a solution with a solid concentration of 0.6% by weight prepared by diluting a thiophene polymer-containing solution (Denatron P521-AC (trade name) manufactured by Nagase ChemteX Corporation) with a mixture solution of water and isopropyl alcohol. As in Example 1, a silicone-treated PET film having a pressure-sensitive adhesive layer was transferred onto the priming layer, so that a pressure-sensitive adhesive layer-carrying polarizing plate was obtained.

### Example 18 and Comparative Example 4

(Preparation of Thin Polarizing Film and Preparation of Polarizing Plate Therewith)

A process for forming a thin polarizing film was performed. In the process, a laminate including an amorphous PET substrate and a 24-μm-thick PVA layer formed thereon was first subjected to auxiliary in-air stretching at a stretching temperature of 130° C. to form a stretched laminate. Subsequently, the stretched laminate was subjected to dyeing to form a colored laminate, and the colored laminate was subjected to stretching in an aqueous boric acid solution at a stretching temperature of 65° C. to a total stretch ratio of 5.94 times, so that an optical film laminate was obtained, which had a 10-μm-thick PVA layer stretched together with the amorphous PET substrate. Such two-stage stretching successfully formed an optical film laminate having a 10-μm-thick PVA layer formed on the amorphous PET substrate, in which the PVA layer contained highly oriented PVA molecules and formed a highly-functional polarizing film in which iodine adsorbed by the dyeing formed a polyiodide ion complex oriented highly in a single direction. An 80-μm-thick saponified triacetylcellulose film was further bonded to the polarizing film surface of the optical film laminate, while a polyvinyl alcohol-based adhesive was applied to the polarizing film surface. The amorphous PET substrate was then peeled off. Subsequently, while a polyvinyl alcohol-based adhesive was applied to the surface of the polarizing film on the side where the amorphous PET substrate had been peeled off, a retardation plate made of a 33-μm-thick norbornene resin film (ZEONOR FILM ZD12 (trade name) manufactured by ZEON CORPORATION) was bonded as a transparent protective film to the surface of the polarizing film, so that a polarizing plate I having the thin polarizing film was obtained.

(Preparation of Pressure-Sensitive Adhesive Layer-Carrying Polarizing Plate)

In Example 1, pressure-sensitive adhesive layer-carrying polarizing plates of Example 18 and Comparative Example 4 were prepared as in Example 1, except that the polarizing plate type, the acryl-based polymer type, the solid content, the additive type, and the amounts of the components were changed as shown in Table 2.

### Example 19

(Preparation of Polarizing Plate)

A polarizing plate J (99.995 in degree of polarization) was prepared as in Example 18, except that the retardation plate made of the norbornene resin film was not bonded to the pressure-sensitive adhesive-coated side.

(Preparation of Pressure-Sensitive Adhesive Layer-Carrying Polarizing Plate)

In Example 18, a pressure-sensitive adhesive layer-carrying polarizing plate of Example 19 was prepared as in Example 18, except that the polarizing plate type, the acryl-based polymer type, the solid content, the additive type, and the amounts of the components were changed as shown in Table 2.

The pressure-sensitive adhesive layer-carrying polarizing plates (samples) obtained in the examples and the comparative examples were evaluated as described below. The results are shown in Table 2.

[Measurement of Solid Content]

About 1 g of the pressure-sensitive adhesive composition was placed in a tin petri dish with a precisely known weight (A). After their total weight (B) was precisely measured, the composition was heated at 100° C. for 4 hours. After the heating, their total weight (C) was precisely measured. The solid content (base) of the composition was calculated from the formula below using the measured weights.

(Base (%))=100×[(the weight (C−A) after the heating)/(the weight (B−A) before the heating)]

[Viscosity of Pressure-Sensitive Adhesive Coating Liquid]

The viscosity (P) of the pressure-sensitive adhesive coating liquid was measured using VISCOMETER Model BH manufactured by Toki Sangyo Co., Ltd under the following conditions.

Rotor: No. 4

Rotational speed: 20 rpm

Measurement temperature: 30° C.

[Evaluation of Gel]

After the polymerization of the (meth)acryl-based polymer, the resulting pressure-sensitive adhesive composition was filtered through a 1 μm mesh screen. The quantity of gel remaining on the screen was visually evaluated according to the following criteria.

O: No gel remains.

Δ: A small amount of gel remains.

x: A large amount of gel remains.

[Evaluation of Coating Appearance]

The pressure-sensitive adhesive solution was filtered through a 1 μm mesh screen and then applied with a fountain die coater to one side of a 38-μm-thick, silicone-treated PET film (MRF38 manufactured by Mitsubishi Chemical Polyester Film Co., Ltd.) so that a 20-μm-thick pressure-sensitive adhesive layer could be formed after drying. The appearance of the freshly-formed coating was visually observed.

⊙: The coating appearance is very good with no streaks, bubbles, whitening, or other defects and is acceptable for practical use.

◯: The coating appearance is good and acceptable for practical use although streaks, bubbles, whitening, or other defects slightly occur.

Δ: The coating appearance is acceptable for practical use but streaks, bubbles, whitening, or other defects occur in places.

x: Streaks, bubbles, whitening, or other defects occur in many places, and the coating appearance is not acceptable for practical use.

[Properties on ITO (Evaluation of Corrosion Prevention)]

A touch panel layer-carrying liquid crystal panel was provided including a liquid crystal panel and a touch panel layer formed on one side of the liquid crystal panel. The pressure-sensitive adhesive layer-carrying polarizing plate was cut into a piece of 10 mm×150 mm, and the cut piece was bonded to the uppermost surface (ITO-coated surface) of the touch panel layer with its pressure-sensitive adhesive layer interposed therebetween. A silver ink composition was then printed on 5-mm-wide parts at both long-side ends to form electrodes. The silver print was then dried by being allowed to stand at room temperature for 24 hours. The initial resistance (RO) of the prepared sample was measured, and then the sample was stored under the conditions of 65° C. and 95% RH for 150 hours. After this endurance test, the resistance (R1) of the sample was measured. The rate (R1/R0) of change from the initial resistance (R0) was then calculated for the evaluation of ITO degradation. The resistance was measured using Digital mΩ HiTESTER 3540 manufactured by HIOKI E. E. CORPORATION with its electrodes attached to the silver paste parts at both ends. When the rate of resistance change is less than 20%, corrosion prevention is considered to be successful.

◯: Almost no degradation occurs, and there is no practical problem.

Δ: Some degradation is observed, but there is no practical problem.

x: Degradation is significant, and there is a practical problem.

[Properties on ITO (Evaluation of Durability)]

Each sample was cut into a piece of 420 mm length and 320 mm width. The sample piece was bonded to the ITO-coated surface of a liquid crystal panel using a laminator. The sample piece was then autoclaved at 50° C. and 5 atm for 15 minutes to be completely bonded to the non-alkali glass plate. After this process, the sample piece was stored at 80° C. for 500 hours (heating test) and further stored at 60° C. and 90% RH for 500 hours (humidity test). The state of foaming, peeling, and lifting of the sample piece was then visually evaluated according to the following criteria.

⊙: Any change in appearance, such as foaming, peeling, or lifting is not observed at all.

◯: Peeling at an end part or foaming is slightly observed, but there is no practical problem.

Δ: Peeling at an end part or foaming is observed, but there is no practical problem if the intended use is not special.

x: Peeling at an end part or foaming is significantly observed, and there is a practical problem.

[Properties on ITO (Evaluation of Removability)]

Each sample was cut into a piece of 420 mm length and 320 mm width. The sample piece was bonded to the ITO-coated surface of a liquid crystal panel using a laminator, and then completely bonded by being autoclaved at 50° C. and 5 atm for 15 minutes. Subsequently, the sample piece was peeled off by hand from the non-alkali glass plate when the reworkability was evaluated according to the following criteria.

◯: The film is successfully peeled off without being broken.

Δ: The film is broken but entirely peeled off by repeated peeling.

x: The film is broken and is not peeled off even by repeated peeling.

[Evaluation of Display Quality (Contaminant-Induced Defects)]

The pressure-sensitive adhesive layer-carrying polarizing plates were bonded to the upper and lower sides of a liquid crystal panel with a contrast of 5,000:1 in the crossed-Nicols arrangement. It was visually observed whether display defects caused by pressure-sensitive adhesive gel-derived contaminants appeared in the black state when an LED backlight module with a brightness of 10,000 cd was used. The evaluation was performed using BRAVIA 46-inch TV (KDL-46HX900) manufactured by Sony Corporation.

⊙: No contaminant-induced defects are observed, and there is no practical problem.

◯: Although contaminant-induced defects are slightly observed, there is no practical problem.

Δ: Although contaminant-induced defects are observed to a certain extent, there is no practical problem.

x: Many contaminant-induced defects are observed, and there is a practical problem.

TABLE 2

| | | | Pressure-sensitive adhesive | | | | | | | | |
|---|---|---|---|---|---|---|---|---|---|---|---|
| | Polarizing | | Acrylic | | | | | Solid | | | |
| | plate | | polymer | | | | | content | Viscosity | Gel | Coating |
| | Type | Priming | type | NYPER | C/L | OL-1 | SAT10 | (%) | [Pa · s] | formation | appearance |
| Example 1 | X | Absent | A | 0.3 | 1 | — | 0.5 | 20 | 3.5 | ◯ | ⊙ |
| Example 2 | X | Absent | A | 0.3 | 1 | — | 0.5 | 24 | 5.7 | ◯ | ⊙ |
| Example 3 | X | Absent | A | 0.3 | 1 | — | 0.5 | 30 | 10.6 | ◯ | Δ |
| Example 4 | X | Absent | B | 0.3 | 1 | — | 0.5 | 24 | 3.1 | ◯ | ⊙ |
| Example 5 | X | Absent | B | 0.3 | 1 | — | 0.5 | 40 | 8.3 | ◯ | ◯ |
| Example 6 | X | Absent | C | 0.3 | 1 | — | 0.5 | 20 | 6.1 | ◯ | ⊙ |
| Example 7 | X | Absent | C | 0.3 | 1 | — | 0.5 | 24 | 8.5 | ◯ | ⊙ |
| Example 8 | X | Absent | D | 0.3 | 1 | — | 0.5 | 24 | 5.5 | ◯ | ⊙ |
| Example 9 | X | Absent | A | 0.3 | 3 | — | 0.5 | 24 | 5.7 | ◯ | ◯ |
| Example 10 | X | Absent | A | 0.3 | 5 | — | 0.5 | 24 | 5.7 | ◯ | Δ |
| Example 11 | X | Absent | A | 0.3 | 7 | — | 0.5 | 24 | 5.7 | Δ | Δ |
| Example 12 | X | Absent | A | 0.3 | 1 | 0.1 | 0.5 | 24 | 5.7 | Δ | ◯ |
| Example 13 | X | Absent | A | 0 | 2 | — | 0.5 | 20 | 3.5 | ◯ | ⊙ |
| Example 14 | X | Present | A | 0.3 | 1 | — | 0.5 | 20 | 3.5 | ◯ | ⊙ |
| Example 15 | X | Absent | H | 0.3 | 0.8 | — | 0.5 | 25 | 6.2 | ◯ | ⊙ |
| Example 16 | X | Absent | I | 0.3 | 0.6 | — | 0.5 | 25 | 6.5 | ◯ | ◯ |
| Example 17 | X | Absent | J | 0.3 | 0.4 | — | 0.5 | 25 | 6.6 | Δ | Δ |
| Example 18 | I | Absent | H | 0.3 | 0.8 | — | 0.5 | 25 | 6.2 | ◯ | ⊙ |
| Example 19 | J | Absent | H | 0.3 | 0.8 | — | 0.5 | 25 | 6.2 | ◯ | ⊙ |
| Comparative | X | Absent | E | 0.3 | 1 | — | 0.5 | 25 | 5.2 | X | ◯ |
| Example 1 | | | | | | | | | | | |
| Comparative | X | Absent | F | 0.3 | 1 | — | 0.5 | 25 | 2.1 | ◯ | ◯ |
| Example 2 | | | | | | | | | | | |
| Comparative | X | Absent | G | 0.3 | 1 | — | 0.5 | 12 | 5.6 | X | ◯ |
| Example 3 | | | | | | | | | | | |
| Comparative | I | Absent | G | 0.3 | 1 | — | 0.5 | 12 | 5.6 | X | ◯ |
| Example 4 | | | | | | | | | | | |

| | Properties on ITO | | | | | | Display quality | | |
|---|---|---|---|---|---|---|---|---|---|
| | | Rate of | | | | 60° C.- | Contaminant- | | B/L |
| | Resistance | change | Corrosion | | Durability | 90% | induced | | bright- |
| | [kΩ] | [%] | prevention | Removability | at 80° C. | RH | defects | Contrast | ness |
| Example 1 | 1.07 | 1.8 | ◯ | ◯ | ◯ | ◯ | ⊙ | 5000:1 | 10000 |
| Example 2 | 1.14 | 7.8 | ◯ | ◯ | ◯ | ◯ | ⊙ | 5000:1 | 10000 |
| Example 3 | 0.98 | 7.3 | ◯ | ◯ | ◯ | ◯ | ⊙ | 5000:1 | 10000 |
| Example 4 | 1.13 | 6.7 | ◯ | ◯ | Δ | Δ | ⊙ | 5000:1 | 10000 |
| Example 5 | 1.04 | 1.5 | ◯ | ◯ | Δ | Δ | ⊙ | 5000:1 | 10000 |
| Example 6 | 1.17 | 10.9 | ◯ | ◯ | ⊙ | ⊙ | ⊙ | 5000:1 | 10000 |
| Example 7 | 0.94 | 11.0 | ◯ | ◯ | ⊙ | ⊙ | ⊙ | 5000:1 | 10000 |
| Example 8 | 1.14 | 8.1 | ◯ | ◯ | Δ | Δ | ⊙ | 5000:1 | 10000 |
| Example 9 | 1.15 | 8.5 | ◯ | ◯ | ◯ | ◯ | ◯ | 5000:1 | 10000 |
| Example 10 | 1.15 | 8.5 | ◯ | ◯ | ◯ | ◯ | ◯ | 5000:1 | 10000 |
| Example 11 | 1.18 | 11.4 | ◯ | ◯ | ◯ | ◯ | Δ | 5000:1 | 10000 |
| Example 12 | 1.18 | 11.5 | ◯ | ◯ | ◯ | ◯ | Δ | 5000:1 | 10000 |
| Example 13 | 1.09 | 3.3 | ◯ | ◯ | Δ | Δ | ⊙ | 5000:1 | 10000 |
| Example 14 | 1.07 | 1.8 | ◯ | ◯ | ◯ | ◯ | ⊙ | 5000:1 | 10000 |
| Example 15 | 1.20 | 13.7 | ◯ | ◯ | ⊙ | ⊙ | ⊙ | 5000:1 | 10000 |
| Example 16 | 1.13 | 7.1 | ◯ | ◯ | ⊙ | ⊙ | ◯ | 5000:1 | 10000 |
| Example 17 | 0.99 | 6.2 | ◯ | ◯ | ⊙ | ⊙ | Δ | 5000:1 | 10000 |
| Example 18 | 1.19 | 12.8 | ◯ | ◯ | ⊙ | ⊙ | ◯ | 5000:1 | 10000 |
| Example 19 | 1.19 | 12.8 | ◯ | ◯ | ⊙ | ⊙ | Δ | 5000:1 | 10000 |
| Comparative | 7.39 | 600.5 | X | X | ⊙ | ⊙ | X | 5000:1 | 10000 |
| Example 1 | | | | | | | | | |
| Comparative | 0.90 | 15.1 | ◯ | Δ | X | Δ | ◯ | 5000:1 | 10000 |
| Example 2 | | | | | | | | | |
| Comparative | 1.11 | 5.6 | ◯ | X | ⊙ | ⊙ | X | 5000:1 | 10000 |
| Example 3 | | | | | | | | | |
| Comparative | 1.11 | 5.6 | ◯ | X | ⊙ | ⊙ | X | 5000:1 | 10000 |
| Example 4 | | | | | | | | | |

In Table 2, “NYPER” represents dibenzoyl peroxide (NYPER BMT (SV) manufactured by NOF CORPORATION), “C/L” CORONATE L manufactured by Nippon Polyurethane Industry Co., Ltd. (tolylene diisocyanate adduct of trimethylolpropane), “OL-1” a crosslinking accelerator (dioctyltin laurate (EMBILIZER OL-1 (trade name) manufactured by Tokyo Fine Chemical CO., LTD.), “SAT10” a polyether compound (Silyl SAT10 manufactured by Kaneka Corporation), and “B/L brightness” the brightness of the LED backlight.

The results in Table 2 show the following. When the pressure-sensitive adhesive layer was made from the pressure-sensitive adhesive composition of each of Examples 1 to 19, microgel formation was significantly reduced. In addition, because the (meth)acryl-based polymer did not contain any carboxyl group-containing monomer, the pressure-sensitive adhesive layer made from the composition of each of Examples 1 to 19 did not cause corrosion even when bonded to the ITO surface, and the pressure-sensitive adhesive layer made from the composition of each of Examples 1 to 19 had a high level of removability and durability and formed very few contaminant-induced defects, so that high display quality was obtained. Particularly when the pressure-sensitive adhesive layer was made from the pressure-sensitive adhesive composition of each of Examples 18 and 19, almost no contaminant-induced defects were observed, even though the polarizing plate used had a thin polarizing film. In contrast, when the pressure-sensitive adhesive layer was made from the pressure-sensitive adhesive composition of each of Comparative Examples 1, 3, and 4, the content of microgel was relatively high, and thus contaminant-induced defects occurred significantly, so that low display quality was obtained. When the pressure-sensitive adhesive layer was made from the pressure-sensitive adhesive composition of Comparative Example 2, good display quality was obtained, but removability and durability were low because the (meth)acryl-based polymer in the composition had a relatively low molecular weight.

Durability tends to be slightly lower when the pressure-sensitive adhesive composition of Example 13 is used, which contains the (meth)acryl-based polymer A but does not contain a peroxide, than when the pressure-sensitive adhesive composition of each of Examples 1 to 3, 9 to 12, 14, and 15 to 19 is used, which contains the (meth)acryl-based polymer A. This result shows that to improve durability, it is more preferable to perform crosslinking with a radical generating agent.

Next, it was examined whether display defects caused by pressure-sensitive adhesive gel-induced contaminants appeared in the black state, using the same conditions as those in Example 1, except that a pressure-sensitive adhesive layer-carrying polarizing plate produced with the pressure-sensitive adhesive composition of Comparative Example 3 was used instead and that the contrast and the brightness of the LED backlight module were changed. The results are shown in Table 3. When the polarizing plate with a degree of polarization different from that of the polarizing plate X was prepared, the conditions under which the polyvinyl alcohol film was immersed in the iodine solution were changed in the process of preparing the polarizer.

TABLE 3

| | | Pressure-sensitive adhesive | | | | | | | | Display quality | | |
|---|---|---|---|---|---|---|---|---|---|---|---|---|
| | Polarizing | Acrylic | | | | | Solid | | | Contaminant- | | B/L |
| | plate | polymer | | | | | content | Viscosity | Gel | induced | | bright- |
| | Type | type | NYPER | C/L | OL-1 | SAT10 | (%) | [Pa · s] | formation | defects | Contrast | ness |
| Comparative | X | G | 0.3 | 1 | — | 0.5 | 12 | 5.6 | X | X | 5000:1 | 10000 |
| Example 3 | | | | | | | | | | | | |
| Reference | X | G | 0.3 | 1 | — | 0.5 | 12 | 5.6 | X | Δ | 3000:1 | 10000 |
| Example 1 | | | | | | | | | | | | |
| Reference | X | G | 0.3 | 1 | — | 0.5 | 12 | 5.6 | X | ◯ | 700:1 | 10000 |
| Example 2 | | | | | | | | | | | | |
| Reference | X | G | 0.3 | 1 | — | 0.5 | 12 | 5.6 | X | Δ | 5000:1 | 5000 |
| Example 3 | | | | | | | | | | | | |
| Reference | X | G | 0.3 | 1 | — | 0.5 | 12 | 5.6 | X | ◯ | 5000:1 | 2000 |
| Example 4 | | | | | | | | | | | | |
| Reference | Y | G | 0.3 | 1 | — | 0.5 | 12 | 5.6 | X | Δ | 5000:1 | 10000 |
| Example 5 | | | | | | | | | | | | |
| Reference | Z | G | 0.3 | 1 | — | 0.5 | 12 | 5.6 | X | ◯ | 5000:1 | 10000 |
| Example 6 | | | | | | | | | | | | |
| Reference | X | Absent | 0.3 | 1 | — | 0.5 | 12 | 5.6 | X | ⊙ | 700:1 | 5000 |
| Example 7 | | | | | | | | | | | | |
| Reference | Y | Absent | 0.3 | 1 | — | 0.5 | 12 | 5.6 | X | ⊙ | 700:1 | 10000 |
| Example 8 | | | | | | | | | | | | |
| Reference | Z | Absent | 0.3 | 1 | — | 0.5 | 12 | 5.6 | X | ⊙ | 3000:1 | 10000 |
| Example 9 | | | | | | | | | | | | |

In Table 3, “polarizing plate X” represents the same polarizing plate (with a degree of polarization of 99.995) as used in the preparation of the pressure-sensitive adhesive layer-carrying polarizing plate of Example 1, “polarizing plate Y” a polarizing plate with a degree of polarization of 99.98, and “polarizing plate Z” a polarizing plate with a degree of polarization of 99.97.

The results in Table 3 show that even though the pressure-sensitive adhesive layer was made from the same pressure-sensitive adhesive composition as that of Comparative Example 3, contaminant-induced defects were few and display quality was acceptable when the panel had a low contrast (Reference Example 2), when the LED backlight module had a low brightness (Reference Example 4), or when the polarizing plate had a low degree of polarization (Reference Example 6). In other words, this suggests that when the pressure-sensitive adhesive layer was made from the pressure-sensitive adhesive of each of Examples 1 to 19, high display quality was obtained even though the contrast of the panel, the brightness of the LED backlight module, and the degree of polarization of the polarizing plate were higher than those of conventional ones, because the amount of the formed microgel was very small.

1. A pressure-sensitive adhesive composition for use on an optical film, comprising:
a (meth)acryl-based polymer obtained by copolymerization of 30 to 98.9% by weight of an alkyl(meth)acrylate, 1 to 50% by weight of an aromatic ring-containing polymerizable monomer, and 0.1 to 20% by weight of a hydroxyl group-containing monomer, the (meth)acryl-based polymer being free of any carboxyl group-containing monomer unit and having a weight average molecular weight of 300,000 to 1,200,000 as measured by gel permeation chromatography; and
a solvent, wherein
the content of a solid including the (meth)acryl-based polymer is 20% by weight or more, and the content of the solvent is 80% by weight or less.

2. The pressure-sensitive adhesive composition for use on an optical film according to claim 1, wherein the aromatic ring-containing polymerizable monomer is benzyl(meth)acrylate.

3. The pressure-sensitive adhesive composition for use on an optical film according to claim 1, wherein the hydroxyl group-containing monomer is 4-hydroxybutyl acrylate.

4. The pressure-sensitive adhesive composition for use on an optical film according to claim 1, further comprising 0.02 to 2 parts by weight of a radical generating agent based on 100 parts by weight of the (meth)acryl-based polymer.

5. The pressure-sensitive adhesive composition for use on an optical film according to claim 1, further comprising 0.01 to 5 parts by weight of an isocyanate crosslinking agent based on 100 parts by weight of the (meth)acryl-based polymer.

6. A pressure-sensitive adhesive layer for use on an optical film, comprising a product made from the pressure-sensitive adhesive composition for use on an optical film according to claim 1.

7. A pressure-sensitive adhesive layer-carrying optical film comprising an optical film and the pressure-sensitive adhesive layer for use on an optical film according to claim 6 formed on at least one side of the optical film.

8. The pressure-sensitive adhesive layer-carrying optical film according to claim 7, wherein the optical film is a polarizing plate comprising a polarizer and a transparent protective film or films provided on one or both sides of the polarizer.

9. The pressure-sensitive adhesive layer-carrying optical film according to claim 8, wherein the polarizer has a thickness of 10 μm or less.

10. An image display device comprising at least one piece of the pressure-sensitive adhesive layer-carrying optical film according to claim 7.
